(19) United States
(12) Patent Application Publication
(10) Pub. No.: US 2010/0324927 A1
(43) Pub. Date: Dec. 23, 2010

(54) SENIOR CARE NAVIGATION SYSTEMS AND METHODS FOR USING THE SAME

(76) Inventor: Eric C. Tinsley, Carmel, IN (US)

Correspondence Address: ICE MILLER LLP, ONE AMERICAN SQUARE, SUITE 3100, INDIANAPOLIS, IN, 46282-0200, US

(21) Appl. No.: 12/817,329

(22) Filed: Jun. 17, 2010

Related U.S. Application Data
(60) Provisional application No. 61/233,339, filed on Aug. 12, 2009.
(60) Provisional application No. 61/225,690, filed on Jul. 15, 2009.
(60) Provisional application No. 61/187,830, filed on Jun. 17, 2009.

(51) Int. Cl. G06Q 50/00; G06Q 10/00; G06N 5/02; G06F 15/18; G06F 17/30

(52) U.S. Cl. 705/2; 706/50; 706/47; 706/12; 707/723; 707/E17.014

(57) ABSTRACT

Senior care navigation systems and methods for using the same. In at least one exemplary system for utilizing and analyzing information to provide a desired outcome of the present disclosure, the system comprises an evidence repository comprising at least one item of evidence from each of at least two evidentiary sources, and a knowledge management and decision support system in communication with the evidence repository, the knowledge management and decision support system operable to retrieve the at least one item of evidence from the evidence repository and process the at least one item of evidence according to at least one reasoning approach, the knowledge management and decision support system further operable to generate at least one outcome.

### PRIORITY

The present U.S. Nonprovisional patent application is related to, and claims the priority benefit of, U.S. Provisional Patent Application Ser. No. 61/233,339, filed Aug. 12, 2009, U.S. Provisional Patent Application Ser. No. 61/225,690, filed Jul. 15, 2009, and U.S. Provisional Patent Application Ser. No. 61/187,830, filed Jun. 17, 2009, the contents of which are hereby incorporated by reference in their entirety into this disclosure

### BACKGROUND

The increasing population of older Americans is a well documented phenomenon. By 2030 the population of seniors (those adults over age 65) in the United States will be 71.5 million, more than doubling in just 30 years. This dramatic increase is becoming a major public policy issue with a significant potential impact on individuals themselves and the health care industry. While it is evident that the demand for medical care specific to seniors will increase, the number of physicians and nurses skilled and specialized in geriatric medicine is predicted to fall far short of the need. There is also a requirement for significantly more professional geriatric care management, family caregiving and community support resources, if the aging population is to receive adequate support. The needs and expectations of the baby boomer generation cannot be met under the current systems. To help cope with this problem a new industry, geriatric care management, is emerging as a complement to the health care system.

Unfortunately, while technology and informatics are penetrating the medical provider world with protocols, decision aids, and guidelines, no similar use of informatics is focused on non-clinical geriatric care management and support. A key human resource dedicated to this problem is the geriatric care manager: usually an independent, consumer side (rather than provider side) nurse or social worker who assists older adults and their families. The lack of technology-supported aids and tools limits the effectiveness of individual geriatric care managers to their education and personal experience.

Older adults and their families are facing challenging times in their attempts to achieve desired health outcomes and overall well-being. The current health care system, with multiple health providers, complex resources, and fragmented care models, creates a complicated and confusing environment for seniors and their families. A major resource available to provide help on a holistic, one-on-one basis is a geriatric care manager. These care managers do not provide medical care, but instead provide a bridge between the health providers, seniors, and their families.

Unfortunately, there is no standard or uniform set of qualifications for geriatric care managers, and the quality of the assistance provided is usually defined by the skills and experiences—and even prejudices—of the individuals providing the help.

The focus of this new industry is on caregiving and family support rather than diagnosis and treatment. Geriatric care management seeks to help seniors follow the treatment plans recommend by the medical delivery community and create a safe environment where seniors and their caregivers can have the highest quality of life. Typically these caregivers are family members and as the level of care increases the physical, emotional, and financial stresses rise as well. Geriatric care managers step in to provide information, practical advice, support, and organization.

In addition to concerns over stress, caregiving has an economic impact as well. Estimates based on 1997 data indicate that some 24 billion hours were spent in caregiving that year. More recently, Metlife examined the productivity loses to U.S. business. This 2006 study found that employers were facing a $33.6 billion cost. The majority of these caregivers, nearly 80%, were caring for someone over the age of 50.

Geriatric care management, like most new industries, is fragmented and undisciplined. While the health care industry has developed (and continues to improve) national standards, protocols for diagnosis and care, and methods for formally evaluating the validity of these approaches, geriatric care management has been left to the experience and knowledge of individual practitioners.

As such, it would be beneficial to provide systems and methods to help solve this problem, including the creation of a geriatric care system using predictable, total quality-managed processes and information technology to support its professional health care managers and business partners in assisting seniors and their families with the issues and options of aging.

### BRIEF SUMMARY

The disclosure of the present application provides various systems for handling and processing knowledge and methods of using and performing the same. In at least one embodiment, referred to herein as SCANS, an exemplary system is operable to process geriatric care data and provide various care plans.

In at least one embodiment of a system for utilizing and analyzing information to provide a desired outcome of the present disclosure, the system comprises an evidence repository comprising at least one item of evidence from each of at least two evidentiary sources, and a knowledge management and decision support system in communication with the evidence repository, the knowledge management and decision support system operable to retrieve the at least one item of evidence from the evidence repository and process the at least one item of evidence according to at least one reasoning approach, the knowledge management and decision support system further operable to generate at least one outcome. In another embodiment, the at least two evidentiary sources are selected from the group consisting of standards of care, clinical expertise, and member records. In yet another embodiment, at least one of the at least two evidentiary sources comprises standards of care, and wherein the standards of care comprise the at least one item of evidence selected from the group consisting of research reports, care guidelines, and practice standards. In an additional embodiment, at least one of the at least two evidentiary sources comprises clinical expertise, and wherein the clinical expertise comprises field evidence. In yet an additional embodiment, at least one of the at least two evidentiary sources comprises member records, and wherein the member records comprise internal research evidence from at least one member record source.

In at least one embodiment of a system for utilizing and analyzing information to provide a desired outcome of the present disclosure, the at least one item of evidence within the evidence repository was extracted and provided to the evidence repository by establishing patterns for translation from text from at least one of the at least two evidentiary sources to at least one medical ontology by observing regularities in the text and mapping the irregularities to control structures in the at least one medical ontology. In an additional embodiment, the at least one reasoning approach is selected from the group consisting of rule-based reasoning, a Semantic Web inference engine, a Bayesian network model, a neural network, and case-based reasoning. In another embodiment, the at least one reasoning approach comprises two reasoning approaches comprising rule-based reasoning and a Bayesain network model. In yet another embodiment, the at least one outcome is selected from the group consisting of a member outcome, a case manager outcome, a cost/utility return-on-investment data, and a documented report.

In at least one embodiment of a system for utilizing and analyzing information to provide a desired outcome of the present disclosure, the at least one item of evidence within the evidence repository was extracted and provided to the evidence repository by abstracting the at least one item of evidence into one or more evidence tables, linking the one or more evidence tables in a knowledge base using an algorithm, and utilizing an ontology-driven extraction of linguistic patterns to reconstruct knowledge from at least one of the at least two evidentiary sources. In another embodiment, the algorithm is selected from the group consisting of a concatenation algorithm and an unsupervised decision list algorithm, the unsupervised decision list algorithm operable to learn extraction patterns and based upon Population, Intervention or interest, Comparison intervention or group, and Outcome (PICO) search settings.

In at least one embodiment of a method for utilizing and analyzing information to provide a desired outcome of the present disclosure, the method comprises the steps of operating a system for utilizing and analyzing information to generate at least one outcome, the system comprising an evidence repository comprising at least one item of evidence from each of at least two evidentiary sources, and a knowledge management and decision support system in communication with the evidence repository, the knowledge management and decision support system operable to retrieve evidence from the evidence repository and process the at least one item of evidence according to at least one reasoning approach, the knowledge management and decision support system further operable to generate at least one outcome, and utilizing the at least one outcome to provide at least one service to a client.

In at least one embodiment of a system for preparing a care plan of the present disclosure, the system comprises a database capable of receiving client data, and a processor operably connected to the database, the processor having and executing a program and operational to access one or more primary categories, one or more secondary categories within the one or more primary categories, and one or more tertiary categories within the one or more secondary categories, access one or more findings, each of the one or more findings relating to one or more recommendations, access one or more tools, the one or more tools capable of addressing one or more of the one or more recommendations, display the one or more findings, the one or more recommendations, and the one or more tools in a desired order, and create a care plan containing the one or more findings, the one or more recommendations, and the one or more tools, the care plan comprising data fields pertaining to the status of the one or more recommendations, the responsibility for addressing the one or more recommendations, and the completion of the one or more recommendations. In another embodiment, the created care plan is stored within a storage medium operably connected to the processor, the storage medium capable of storing multiple care plans. In yet another embodiment, the processor is further operational to execute the program to display multiple care plans.

In at least one embodiment of a method for preparing a care plan of the present disclosure, the method comprises the steps of entering assessment data into a case management system, obtaining an assessment summary based upon the assessment date from the case management system, creating a new care plan in a knowledge management and decision support system, transferring the new care plan to the case management system, and finalizing the new care plan in the case management system.

In at least one embodiment of a system for managing the health care of a client of the present disclosure, the system comprises a case management system operable to receive at least one of assessment data, case notes, and/or outcomes, and a knowledge management and decision support system operable to receive case data from the case management system, the case data relating to the at least one of assessment data, case notes, and/or outcomes, the knowledge management and decision support system further operable to generate one or more care plans and to provide the one or more care plans to the case management system. In an additional embodiment, the generated one or more care plans facilitate client health care management. In yet an additional embodiment, the knowledge management and decision support system is further operable to generate one or more tools and to provide the one or more tools to the case management system.

In at least one embodiment of a method for managing health care of a client of the present disclosure, the method comprises the steps of providing assessment data from at least one of a client, a client's family, and/or a client's spouse to a health care manager, providing at least one of the assessment data, case notes, and/or outcomes from the health care manager to a case management system, operating the case management system to compile case data and to provide the case data to a knowledge management and decision support system; operating the knowledge management and decision support system to generate one or more care plans and to provide the one or more care plans to the case management system; and providing at least one of the one or more care plans from the knowledge management and decision support system and additional client tools to at least one of the client, the client's family, and/or the client's spouse to manage the client's health care.

In at least one embodiment of a system for mining information from various knowledge sources of the present disclosure, the system comprises one or more knowledge sources, a text mining mechanism operable to mine text from the one or more knowledge sources, and a knowledge management and decision support system operable to obtain mined text from the text mining mechanism, obtain information from the one or more knowledge sources either directly or by way of an intermediate expert, and generate one or more plans comprising data based upon the information. In another embodiment, the case data within the generated one or more plans becomes at least one of the one or more knowledge sources. In yet another embodiment, the one or more plans comprises one or more care plans, and wherein the data comprises case data.

In at least one embodiment of an architecture for mining literature of the present disclosure, the architecture comprises one or more literature databases accessible by an object tagging mechanism, one or more medical dictionaries in communication with an object identification mechanism, wherein the object identification mechanism utilizes one or more learning algorithms useful for at least one of concept tagging, identification, and/or association discovery, one or more healthcare-specific knowledge bases in communication with the object tagging mechanism and the object identification mechanism, a system interface, a relationship identification, and a user interface in communication with various dynamic user specific knowledge networks to allow a user to access said networks and portions of said architecture.

In at least one embodiment of a method for generating terms using a term extraction algorithm of the present disclosure, the method comprises the steps of identifying unique tokens appearing in each document of a training corpus, calculating a frequency of each unique token in each document, the total number of documents in which each unique token appears, and a total number of documents in a training set, converting the frequency of each unique token to a weight, and ranking a list of each unique tokens by its weight.

In at least one embodiment of a system for utilizing and analyzing information to provide a desired outcome of the present disclosure, the system comprises an evidence repository, the evidence repository comprising at least one item of evidence from each of at least two evidentiary sources, and a knowledge management and decision support system in communication with the evidence repository, the knowledge management and decision support system operable to retrieve evidence from the evidence repository and process the evidence according to at least one reasoning approach, the knowledge management and decision support system further operable to generate at least one outcome.

In at least one embodiment of a method of delivering content to a case management system and a knowledge management system, the method comprises the steps of delivering information from family, a health system, health care providers, and/or care participants to a senior and/or a geriatric care manager, and delivering the information from the geriatric care manager to a case management system and a knowledge management system.

In at least one embodiment of a system of the present disclosure, the system comprises evidence from standards of care, clinical expertise, and/or member records, a knowledge engine providing for knowledge correlation, the knowledge engine accessible by knowledge system users, and a case management database in communication with a case management system, the case management database operable to transfer case information to the knowledge engine along with recommended solutions. In another embodiment of a system, the case management database is further operable to provide evidence leading to outcomes validation for introduction into the knowledge engine.

In at least one embodiment of a method for utilizing and analyzing information to provide a desired outcome, the method comprises the steps of providing a system for utilizing and analyzing information, utilizing the system to generate the at least one outcome, and utilizing the at least one outcome to provide at least one service to a client.

In at least one embodiment of a system for preparing a care plan, the system comprises a database capable of receiving client data and a processor operably connected to the database, the processor having and executing a program and operational to provide one or more primary categories, one or more secondary categories within the one or more primary categories, and one or more tertiary categories within the one or more secondary categories. In at least one additional embodiment, the processor is further operable to provide one or more findings, each of the one or more findings relating to one or more recommendations, provide one or more tools, the one or more tools capable of addressing one or more of the one or more recommendations, display the one or more findings, the one or more recommendations, and the one or more tools on a desired order, and create a care plan containing the one or more findings, the one or more recommendations, and the one or more tools, the care plan comprising data fields pertaining to the status of one or more recommendations, the responsibility for addressing the one or more recommendations, and the completion of the one or more recommendations.

In at least one embodiment of a method for preparing a care plan, the method comprises the steps of entering assessment data into a case management system, obtaining an assessment summary from the case management system, creating new care plan in a knowledge management and decision support system, transferring the new care plan to the case management system, and finalizing new care plan in the case management system.

### BRIEF DESCRIPTION OF THE DRAWINGS

The features and advantages of the present disclosure, and the manner of attaining them, will be more apparent and better understood by reference to the following descriptions taken in conjunction with the accompanying figures, wherein:

FIG. 1 shows an exemplary knowledge base system according to the present disclosure;

FIG. 2 shows an exemplary preliminary ontology representing geriatric case management knowledge according to the present disclosure;

FIG. 3 shows an exemplary Semantic system according to the present disclosure;

FIG. 4 shows an exemplary case-based reasoning cycle according to the present disclosure;

FIG. 5 shows a diagrammatic view of at least a portion of an exemplary system according to the present disclosure;

FIG. 6A shows an exemplary architecture for mining literature according to the present disclosure;

FIG. 6B shows a schematic representation of an exemplary document identification process according to the present disclosure;

FIG. 6C shows a flowchart of an exemplary method of operation of a term extraction algorithm according to the present disclosure;

FIG. 6D shows an exemplary graph showing document associations according to the present disclosure;

FIG. 7 shows a diagram of various individuals benefiting from and/or providing input to various systems of the present disclosure;

FIG. 8A shows an exemplary knowledge management and decision support system according to the present disclosure;

FIG. 8B shows an exemplary system architecture according to the present disclosure;

FIG. 9A shows a diagram of a situation with multiple paths between nodes according to the present disclosure;

FIG. 9B shows a summary SCANS usage model according to the present disclosure;

FIG. 9C shows an exemplary general knowledge acquisition flow according to the present disclosure;

FIG. 10 shows an exemplary category selection screen of a system for preparing a care plan according to the present disclosure;

FIGS. 11 and 12 show various main categories, secondary categories, and tertiary categories of an exemplary system for preparing a care plan according to the present disclosure;

FIG. 13 shows an exemplary draft care screen of an exemplary system for preparing a care plan according to the present disclosure;

FIGS. 14 and 15 show exemplary view/edit draft care screens of an exemplary system for preparing a care plan according to the present disclosure;

FIGS. 16 and 17 show exemplary care plan options screens of an exemplary system for preparing a care plan according to the present disclosure;

FIG. 18 shows an exemplary care plan summary screen of an exemplary system for preparing a care plan according to the present disclosure;

FIG. 19 shows an exemplary system framework according to the present disclosure; and

FIGS. 20A through 20H show various entity relationship diagrams according to the present disclosure.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

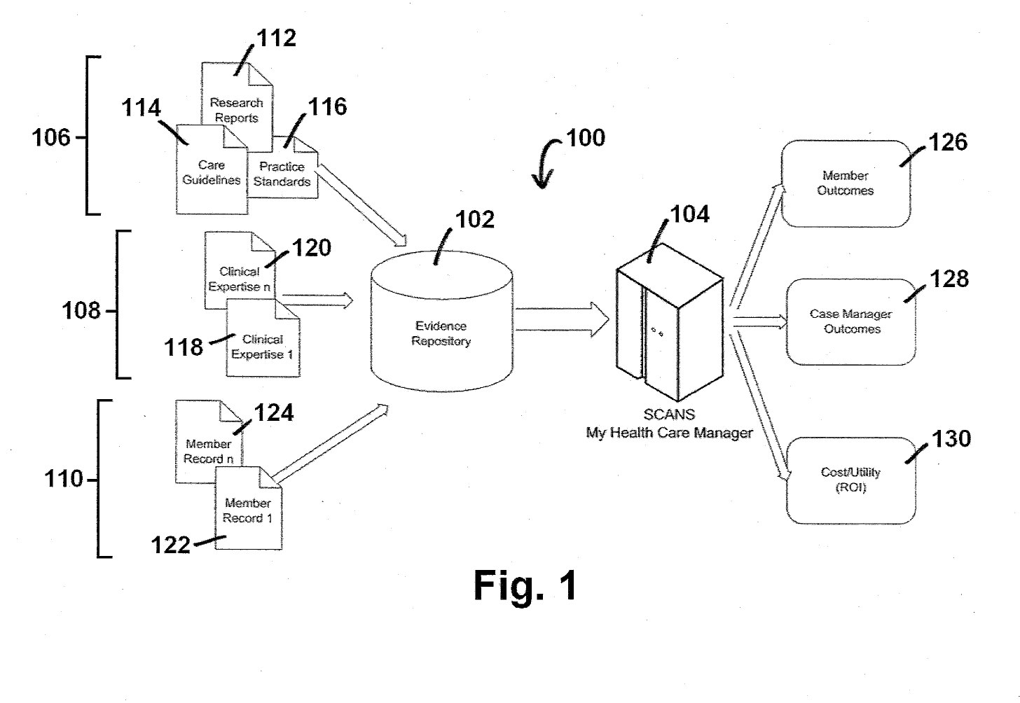

An exemplary knowledge base system 100 of the disclosure of the present application is shown in FIG. 1. As shown in FIG. 1, system 100 comprises an evidence repository 102 and a knowledge management and decision support system 104, an exemplary knowledge management and decision support system 104 referred to throughout the present disclosure as SCANS and/or SCANS 104. Evidence repository 102 comprises evidence from, for example, three evidentiary sources, including standards of care 106, clinical expertise 108, and member records 110, each provided to SCANS 104 within system 100. Standards of care 106 may comprise various types of industry research, for example, evidence from various research reports 112, care guidelines 114, and practice standards 116. Clinical expertise 108 may include, for example, field evidence from multiple clinical expertise sources 118 and 120, and member records may comprise internal research evidence from various member record sources 122 and 124. The number of the standards of care 106, clinical expertise 108, member records 110, and their individual sources may vary, with the numbered items shown in FIG. 1 presented merely as an example to assist with understanding the content of the present disclosure.

Evidence from evidence repository 102, as shown in FIG. 1, may be provided to SCANS 104 for processing in accordance with the disclosure of the present application, to be referenced in further detail herein. The processed information from SCANS 104 may be reported as various member outcomes 126, case manager outcomes 128, and as cost/utility return-on-investment data 130.

The SCANS knowledge base (SCANS 104), as shown in FIG. 1, is built on and comprises distributed expertise and knowledge, merging standards of care 106, current care management knowledge and existing practices (clinical expertise 108), and information from member records 110, dramatically changing the traditional care support service to a technology enhanced evidence based practice for geriatric care management.

The disclosure of the present application highlights a dynamic interaction between the care recipient (member/client), the care manager (Health Care Manager (HCM)), also referred to herein as a Geriatric Care Manager ((GCM) or user), and information technology in the decision making process regarding the care. In at least one embodiment of SCANS 104, SCANS 104 integrates the capacity and preferences of the member extracted from the member profile, competencies and expertise of the HCM, and current evidence based resources available online.

The knowledge building process for system 100 may start with the identification of phenomena of concern for which evidence is sought from a variety of sources, including research, national guidelines, professional practice standards, field experience, and expert opinions related to geriatric care management. The gathered evidence is abstracted into the form of evidence tables that contain specific member records, case management care plans and reports, and expected outcomes. A concatenation algorithm may be used to link the tables in the knowledge base. An ontology-driven extraction of linguistic patterns may then automatically reconstruct the knowledge captured from the online evidence based resources, facilitating a more effective modeling and authoring of evidence based practice guidelines. An unsupervised decision list algorithm that learns extraction patterns from selected geriatric home care practices and related research may also be used. Such an algorithm may operate on the Population, Intervention or interest, Comparison intervention or group, and Outcome (“PICO”) search strings which have been demonstrated to be successful for various EBP searches. The challenge of creating such a knowledge base extends beyond determining which content to make available online. The web based resource, as referenced herein, would be implemented by an organization and/or HCM in order to fit practice situations in the field.

Evidence may be extracted and provided to evidence repository 102 by way of establishing patterns for translation from text to a medical ontology by observing regularities in the text and by mapping them to control structures in the ontology. Since certain narrative text in, for example, care guidelines 114 and practice standards 116, is frequently recurring and regardless of the health care practice, capturing it in a referential model may only require minimal text translation. Examples of referential models include (i) “in case of/event of” (phenomenon), (ii) “the intervention of choice is” (intervention), (iii) “in the event of” (phenomenon), and (iv) “is recommended/used” (care plan).

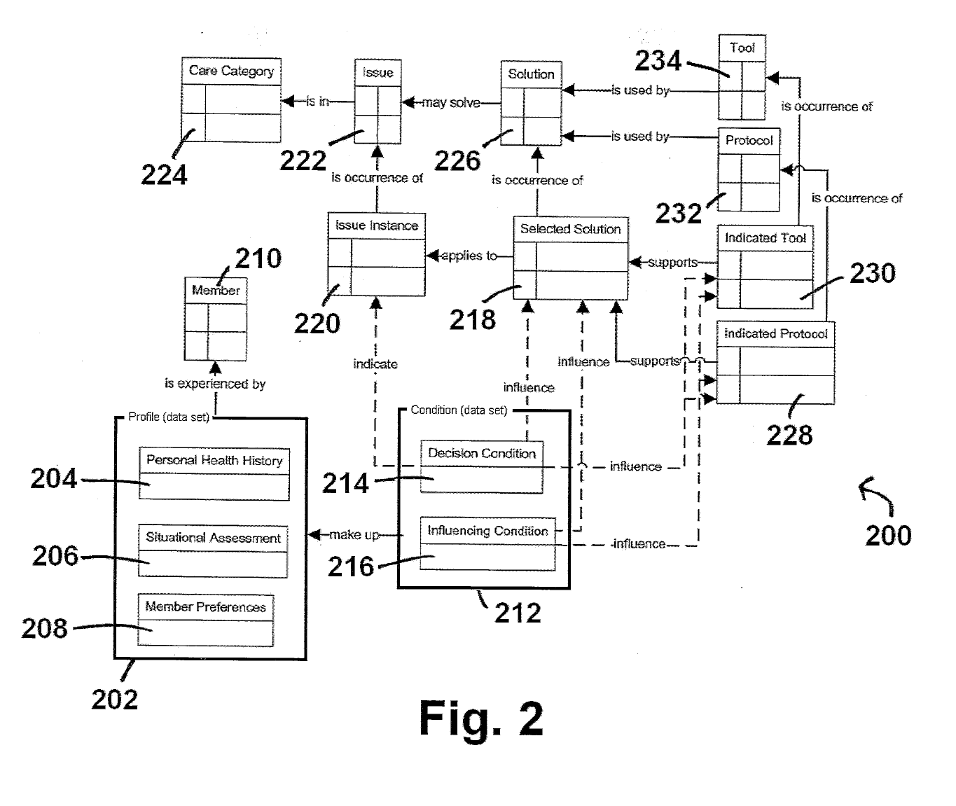

An exemplary preliminary ontology representing geriatric case management knowledge is shown in FIG. 2. The exemplary ontology 200 as shown in FIG. 2 contains “is a” hierarchical relations between concepts, “instance of” relationships between terms and concepts similar and “operator and qualifier” categories similar to Systematized Nomenclature of Medicine-Clinical Terms (SNOMED-CT) and other terminologies within the Unified Medical Language System (UMLS). This exemplary approach may be further developed for the geriatric care management domain as referenced herein.

Member information (member profile 202) may comprise information collected and retained within, for example, the Navigator system as referenced herein. As shown in the exemplary ontology in FIG. 2, Profile (data set) 202 may comprise a Personal Health History 204, which may comprise, for example, a client's non-medical health profile. In at least one embodiment, a Personal Health History 204 does not comprise an Electronic Medical Record (EMR), but can otherwise contain consumer-side information necessary and/or useful to understand and follow various treatment plans prescribed by health providers. The Situational Assessment 206 and Member Preferences 208 may extend the Personal Health History 204 information to consider the many situational and environmental factors affecting the client's/senior's ability to follow treatment plans, noting that the Personal Health History 204, Situational Assessment 206, and Member Preferences 208 either are indicated of or are experienced by Member 210 as shown the exemplary ontology of FIG. 2. This Member 210 information goes further still to deal with factors influencing health. For example, home safety may impact falls or other injuries.

The exemplary ontology 200 shown in FIG. 2 further comprises a Condition (data set) 212, itself comprising Decision Conditions 214 and Influencing Conditions 216 derived from the Profile 202 data. Decision Conditions 214 include those items for which one or more systems of the present disclosure will develop solution recommendations. For example, a condition such as “problems managing multiple medications” can be derived from the number of medications and the in-home evaluation of the HCM. It also qualifies as a Decision Condition 214 because geriatric care management can improve the outcome for the senior and caregivers. Influencing Conditions 216 include those circumstances which change, reorder, or impact the selection of recommended solutions. For example, visual acuity will influence recommendations for solutions and even tools or protocols used to assist in medication management. It should be noted that Decision Conditions 214 may often serve as Influencing Conditions 216 on other knowledge paths. For example, a system of the present disclosure may offer solutions to improve a situation involving depression while at the same time recognizing the impact of depression on solutions to other health related issues.

As shown in FIG. 2, Decision Conditions 214 and Influencing Conditions 216 may influence a Selected Solution 218. In at least one embodiment, recommended Selected Solutions 218 do not comprise medical treatment. A Selected Solution 218 may recommend that medical evaluation and treatment be sought, but not, for example, attempt to diagnose or recommend a treatment course. Geriatric care management solutions involve less clinical recommendations which help to implement and support such medical treatment plans. For example, if depression is suspected, the recommendation would be to have a formal medical evaluation. Next, if depression was diagnosed by a health provider and treatment involved reducing isolation, a system of the present disclosure may/would provide recommendations for specific ways to get the senior involved in more social circumstances. Such recommendations are not trivial, as they must weigh the preferences, capabilities, interests, and other conditions faced by a senior. For example, forcing someone who is naturally introverted to attend large social church functions will likely not be effective in reducing isolation. Such a person may benefit more from joining a small class in a particular area of interest, such as pottery. This would allow them to build a social connection more slowly and around a shared interest. Even a recommendation like this is influenced by the availability of transportation, proximity to adult learning venues, physical mobility and manual dexterity, and so on.

In addition, and as shown in FIG. 2, selected Solutions may apply to Issue Instances 220 which are also indicated by Decision Conditions 214. Issue Instances 220, as shown in FIG. 2, comprise occurrences of Issues 222 in various Care Categories 224, Selected Solutions 218, as shown in FIG. 2, may comprise occurrences of General Solutions 226, which may solve various Issues 222. In addition, various Decision Conditions 214 and Influencing Conditions 216 may influence Indicated Protocols 228 and Indicated Tools 230, both of which may support one or more Selected Solutions 218. Indicated Protocols 228 are occurrences of General Protocols 232, and Indicated Tools 230 are occurrences of General Tools 234, with the General Protocols 232 and General Tools 234 being used by the General Solutions 226 to solve various Issues 222.

The aforementioned building blocks of ontology 200 may then be applied for the automated instantiation and translation of the guidelines, practice standards, and evidence based practice (EBP) research into a referential modeling language. In at least one example, the most frequently used terms in geriatric care management are normalized and semantically tagged to the developed ontology. Such an approach will allow the extraction of knowledge from text in the form of pattern templates, the creation of associations based on relationships, and the identification of pattern instances.

An added benefit of such an exemplary model is that it generates a lexicon and formal model that can be molded to fit different workflows and care plans used by users of the various systems of the present disclosure. For instance, in addition to searching for simple text strings or even Boolean combinations, searches can be expanded to include words that are very close in meaning; words that are related by an ontology, which includes computer-readable relationships among terms and concepts within a hierarchy (such as parent or child); or words that are related by some semantic relationship (such as “is a” and “part of”).

An exemplary knowledge management system of the present disclosure may not only embed knowledge, but may also include various robust processes to translate evidence into practice and collect and use field experience to generate new knowledge.

Regarding the reasoning approaches in connection with knowledge engineering, the Semantic Web may be leveraged as a mechanism for improved care. The Semantic Web is an extension of current Web technologies that enables navigation and meaningful use of digital resources by automatic processes. It is based on common formats that support aggregation and integration of data drawn from diverse sources. The goal of the Semantic Web is to develop enabling standards and technologies designed to help machines understand more information so that they can support richer discovery, data integration, navigation, and automation of tasks.

The various systems, methods, and ontologies of the present disclosure demonstrate that large scale member information, health care management knowledge, and other relevant domain knowledge can be expressed explicitly and quantitatively using Semantic Web technology to improve quality and consistency of service. Semantic Web technology helps achieve these goals in an ontology-driven process involving multiple populated ontologies, automatic semantic annotation of knowledge documents, and rule processing. For purposes of the present disclosure, a knowledge document refers to a variety of documents including, but not limited to, domain specific literature, documented best practices, specific member encounters, provider activities, solutions derived from field experience, standard activities, protocols, and other documents.

A Semantic Web consists of three layers: XML as a syntax layer, a Resource Description Framework (RDF) layer to provide machine-readable descriptions of data that can be parsed, and a third layer, the OWL Web Ontology Language, to combine ontologies, or descriptions of specialized knowledge. Semantic Web standards such as the RDF can be used to help make member information, such as demographic data including age, medical history, and situational analysis available to computer models. Having the data in RDF format allows the Semantic Web Rules Language (SWRL) to be used to write decision support rules for treatments or selecting patients for trials. SWRL may also be used to set criteria for using a particular management intervention or protocol. For example, and by using SWRL, a complex if/then statement may be created. For instance, one combination of criteria and action might be that if a member/client is over 80 years old, has certain conditions, a poor score on an Activities of Daily Living (ADL) assessment, and uses an assistive device, then that member/client would follow a particular defined protocol.

A substantive portion of an exemplary SCANS 104 architecture of the present disclosure is the domain/application ontology. This domain specific information architecture is dynamically updated to reflect changes in the literature, guidelines, field experience, problem specific research and other knowledge sources. An exemplary health care management ontology is populated with knowledge, which is any factual, real-world information about the domain in the form of entities, relationships, attributes, and certain constraints.

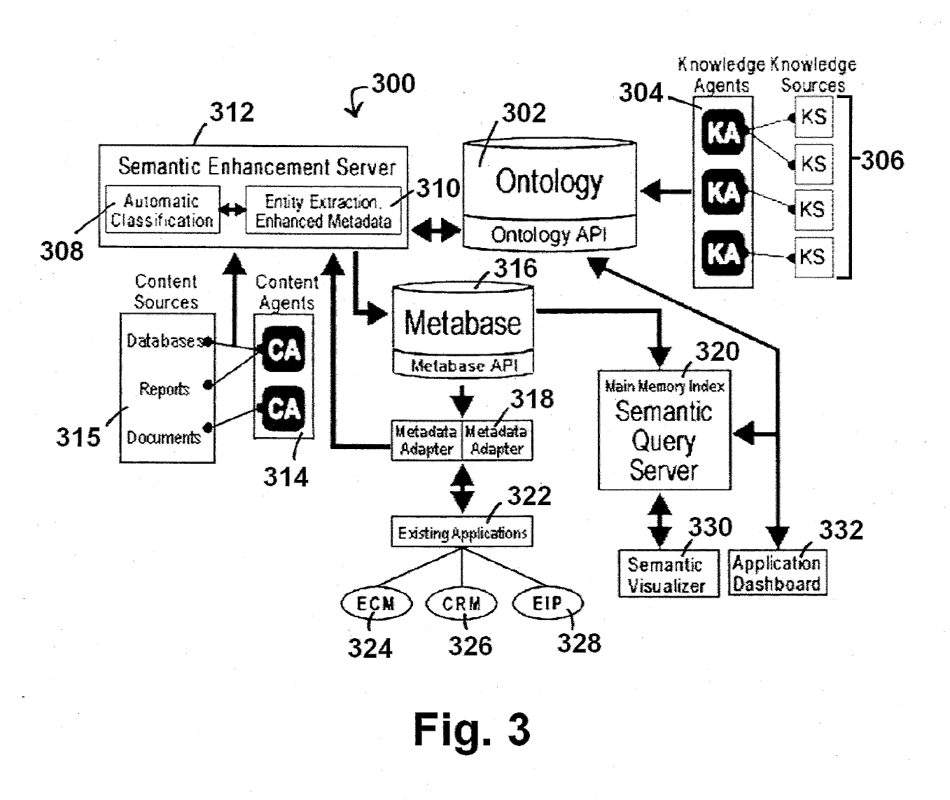

An exemplary Semantic system 300 involving an ontology of the present disclosure is shown in FIG. 3. As shown in FIG. 3, system 300 comprises domain/application ontology 302 The domain/application ontology 302, in at least one embodiment, is automatically maintained by Knowledge Agents 304, as shown in FIG. 3. Knowledge Agents 304 are software agents that traverse trusted knowledge sources 306 that may be heterogeneous and either semi-structured or structured.

Knowledge Agents 304 exploit structure to extract useful entities and relationships for populating the domain/application ontology 302 automatically. Once created, they can be scheduled to automatically keep the domain/application ontology 302 updated with respect to changes in the knowledge sources. Semantic ambiguity resolution is an exemplary useful capability associated with this activity, as well as with the metadata extraction. The domain/application ontology 302 can be exported in RDF/RDFS barring some constraints that cannot be presented in RDF/RDFS.

SCANS 104, as performed at least in part by the exemplary domain/application ontology 302 shown in FIG. 3, is further operable to aggregate structured, semi-structured, and unstructured content from any source and format. In at least one embodiment, and as shown in FIG. 3, two forms of content processing can be supported, namely automatic classification 308 and automatic metadata extraction 310 within Semantic Enhancement Server 312. Automatic classification 308, in an exemplary embodiment, utilizes a classifier committee based on statistical, learning, and knowledge base classifiers. Metadata extraction 310, in at least one embodiment, involves named entity identification and semantic disambiguation to extract syntactic and contextually relevant semantic metadata. Custom meta-tags, driven by business requirements, can be defined at a schema level. Much like Knowledge Agents 304, Content Agents 314, with the ability to access various content sources 315, are software agents.

Incoming content is further enhanced by passing it through the Semantic Enhancement Server 312. The Semantic Enhancement Server 312, as shown in FIG. 3, can (i) identify relevant document features such as currencies, dates, etc., (ii) perform entity disambiguation, (iii) tag the metadata with relevant knowledge (i.e., the instances within the ontology); and (iv) produce a semantically annotated content (that references relevant nodes in the ontology) or a tagged output of metadata. Automatic classification aids metadata extraction and enhancement by providing the context needed to apply the relevant portion of a large ontology.

Semantic Enhancement Server 312, as shown in FIG. 3, is operably connected to metabase 316, which itself is then in communication with one or more metadata adapters 318 and a Semantic Query Server 320. Metadata adapters 318, as shown in FIG. 3, may feed information to Semantic Enhancement Server 312 and various existing applications 322, whereby the various existing applications may comprise enterprise content management (ECM) 324 systems, customer relationship management (CRM) 326 systems, and/or enterprise information portal (EIP) 328 systems. Semantic Query Server 320 may be in communication with a semantic visualizer 330, and may further be in communication with ontology 302 and an application dashboard 332 as shown in FIG. 3.

At least five reasoning approaches, either alone or in combination with one another, may be useful for the automatic creation of a set of health care management solutions for Health Care Managers and their members, which are each based on the mining of protocols. A protocol, as referenced herein, can be understood as a set of rules of a situation leading to a decision (“situation→decision”). The five approaches are described as follows:

1. Rule-Based Reasoning: Rule-Based Reasoning (RBR) is a particular type of reasoning which uses “if-then-else” rule statements. Rules are simply patterns and an inference engine searches for patterns in the rules that match patterns in the data. The “if” means “when the condition is true,” the “then” means “take action A,” and the “else” means “when the condition is not true, take action B.”

Rules can be forward-chaining, also known as data-driven reasoning, because they start with data or facts and look for rules which apply to the facts until a goal is reached. Rules can also be backward-chaining, also known as goal-driven reasoning, because they start with a goal and look for rules which apply to that goal until a conclusion is reached. In addition to individual rule statements, decision tables, formulas, and other lookup techniques can be used to select the outcome of a particular rule evaluation.

In an exemplary embodiment of a SCANS 104 system, member records and information are semantically annotated using one or more relevant OWL ontologies which provide the nomenclature and conceptual model for interpreting and reasoning. Therefore, such an exemplary system can support automatic and dynamic validation and decision making on the content of an identified document. This is accomplished typically by executing rules (such as SWRL) or in the form of the resource description framework query language (RDQL, with potential migration to the simple protocol and resource description framework query language, SPARQL) on semantic annotations and relationships that span across ontologies. SCANS 104, for example, could then display the semantic and lexical annotations in documents displayed in a browser, showing results of rule execution and providing the ability to modify semantic and lexical components of its content in an ontology-supported and otherwise constrained manner.

2. Semantic Web Inference Engines: In this approach the formal ontology is used directly to create a representational model. The model is expanded through the use of rules and an inference engine is used to determine specific results. The rules expressed in SWRL express patterns for evaluating the underlying ontology, providing for fewer rules and a more data driven inference approach. The data itself is expressed in a specific format such as OWL or RDF.

3. Bayesian Network Models: Bayesian Network Models allow a cause and effect relationship to be combined with probabilities, confidences, and other characteristics to provide reasoning outcomes where uncertainty exists. Domain concepts are connected as nodes in a graphical network and conditional probability tables are used to determine likely outcomes. Known “facts” are then asserted at nodes in the network, probabilities are used at nodes where facts are not known and outcomes are determined at decision nodes. Bayesian networks are discussed in further detail below.

4. Neural Networks: Neural Networks provide an automated learning technique capable of reproducing outcomes based on set of asserted facts. Training and validation data sets including facts and associated correct outcomes are used build the Neural Network which can then be used with new sets of facts to predict corresponding outcomes.

5. Case-Based Reasoning: Case-Based Reasoning (CBR) is an approach to problem solving and machine learning that uses previously solved problems as the base for reasoning and learning. A case is a problem situation described by a set of relevant findings. Knowledge is retained in past cases that also have attached the solution for each particular problem. New problems, or cases, are matched to the case-base to find a suitable solution.

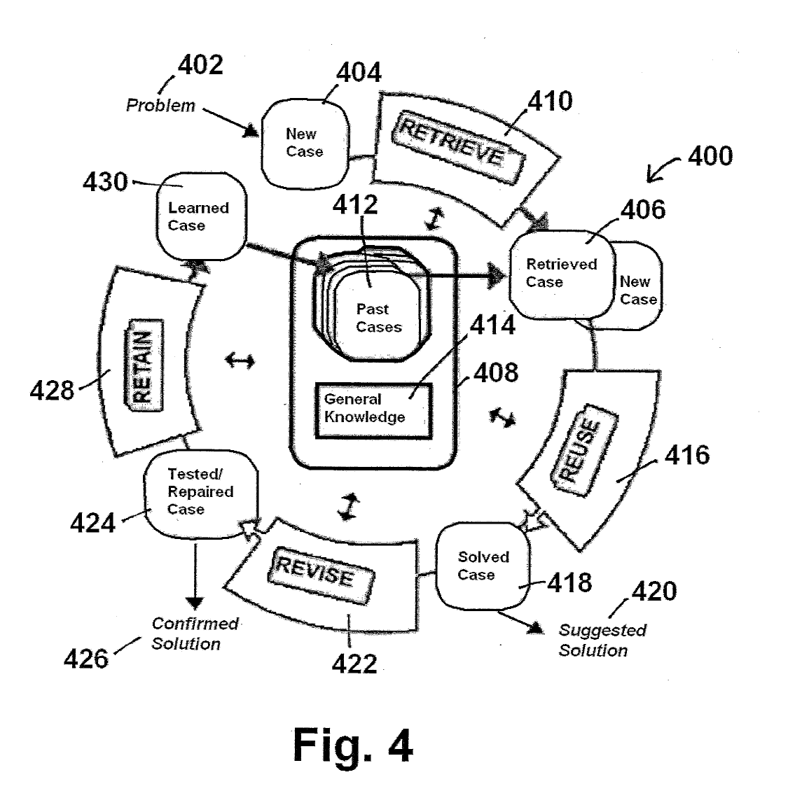

An exemplary four-step CBR cycle is shown in FIG. 4. As shown in FIG. 4, CBR cycle 400 comprises several tasks to be performed upon introduction of a problem 402. When given a new problem 402, and as shown in FIG. 4, a new case 404 is generated, and a relevant case (retrieved case 406) is retrieved from case-base 408 by retrieve step 410. Case base 408, as shown in FIG. 4, may comprise various past cases 412 and general knowledge 414, each of which potentially retrievable by retrieve step 410. Reuse step 416 may be performed based upon retrieved case 406 and/or information from case-base 408 leading to solved case 418 and potentially a suggested solution 420 to problem 402 within new case 404.

To be reused, the suggested solution 420 from solved case 418 may need some adaptation for the new problem 402 at hand. This suggested solution 420 is then tested and revised, and if revisions are necessary and/or desired, revise step 422 may be performed to revise solved case 418, leading to a tested/repaired case 424 and potentially a confirmed solution 426. Revise step 422, as shown in FIG. 4, may also be performed based upon the past cases 412 and/or general knowledge 414 from case-base 408 in connection with the solved case 418. Finally, tested/repaired case 424 and its corresponding confirmed solution 426 is retained by performing retain step 428, leading to a learned case 430 which can then be retained in the case-base 408 for use in future problem solving.

Case-based reasoning differs from traditional rule-based systems in the sense that knowledge is not represented in rules, but in examples. Case-based reasoning builds on the idea that human expertise is not composed of formal structures like rules, but of experience: a human expert reasons by relating a new problem to previous ones. Case-based reasoning now amounts to reasoning by comparing a new problem with a set of stored previous problems with their solution. The solution to the new problem is constructed by retrieving similar problems from memory and adapting their associated solutions to apply to the new problem.

In at least one embodiment of a system of the present disclosure, a hybrid approach was selected involving Rules-Based Reasoning and Bayesian Networks. The evaluation of these approaches was done with minimal regard to implementation toolkits or other components that might be available to speed implementation. Rules-Based reasoning is used to model and traverse simple relationships between findings or derived findings and interventions. During early analysis, and for example, well over three hundred (300) such rules have been identified. Bayesian Networks are used to deal with more complicated reasoning involving multiple findings, derived findings, and assertions to select interventions. Early analysis has identified over forty (40) networks of varying size and complexity requiring this more complicated reasoning. Though these networks can likely be combined into one large network, the approach of linking smaller networks may be selected to allow for easier maintenance and parallel development efforts.

Alongside the approach evaluation, an exemplary search and evaluation for tools was conducted. This exemplary evaluation looked at fifty-two (52) tools and progressively narrowed selection to one tool in combination with the custom software development. The tools were evaluated using ten (10) dimensions and a weighted scoring technique. The dimensions used were as follows, and by way of example, in order of relative importance: (1) Knowledge Authoring, (2) Integration Capabilities, (3) Reasoning Capabilities, (4) Cost, (5) Application Maintenance, (6) Data Access Capabilities, (7) Vendor Strength, (8) Development Tools, (9) Application Development, and (10) Capabilities Semantic Web and Ontology Integration.

By way of example, a case is a problem solving episode which can be represented by a problem Pb and a solution Sol(Pb) of Pb. A case base is a set of cases which are usually structured, called source cases. A source case is denoted by (srce, Sol(srce)). CBR consists in solving a target problem, denoted by tgt, due to the case base. The classical CBR process relies on two steps: retrieval and adaptation. Retrieval aims at finding a source problem srce in the case base that is considered to be similar to tgt. The role of the adaptation task is to adapt the solution of src, Sol(src) in order to build Sol(tgt), a solution of tgt. Then the solution Sol(tgt) is tested, repaired, and, if necessary, memorized for future reuse.

In knowledge intensive case-based reasoning (KI-CBR), the CBR process relies on a formalized model of domain knowledge. This model may contain, for example, an ontology of the application domain, and can be used to organize the case base for case retrieval. KI-CBR may also include some knowledge for adaptation.

Reformulations are basic elements for modeling adaptation knowledge for CBR. A reformulation is a pair (r, Ar) where r is a relation between problems and Ar is an adaptation function: if r relates src to tgt—denoted by “srce r tgt”—then any solution Sol(srce) of srce can be adapted into a solution Sol(tgt) of tgt due to the adaptation function Ar—denoted by “Sol(srce) Ar Sol(tgt)”. In the reformulation model, retrieval consists of finding a similarity path relating srce to tgt, i.e. a composition of relations rk, introducing intermediate problems pbk between the source and the target problems. Every rk relation is linked by a reformulation to an adaptation function Ark.

The model of reformulations is a general framework for representing adaptation knowledge. The operations corresponding to problem relations rk and adaptation functions Ark have to be designed for a particular application. Generally, these operations rely on transformation operations such as specialization, generalization, and substitution, that allow the creation of the pbk problems for building the similarity path and of the Sol(pbk) solutions for the adaptation path: relations of the form pb1 r pb2 and adaptation like Sol(pb1) Ar Sol(pb2) correspond to applications of such transformations. Moreover, the reformulation framework follows the principle of adaptation-guided retrieval. A CBR system using adaptation-guided retrieval retrieves the source cases whose solution is adaptable, i.e. for which adaptation knowledge is available. According to this principle, similarity paths provide a symbolic reification of similarity between problems, allowing the case-based reasoner to build an understandable explanation of the results.

Case-based reasoning, as referenced herein, has several advantages over reasoning with rules. The main advantage is that it is relatively easy to set up a knowledge base. While experience has shown that it is generally very difficult to capture knowledge on a problem domain in a set of rules, examples of problems in this domain with their associated solution are often readily available or can easily be acquired. Another advantage is that case-based reasoning can be used in problem domains that are not well understood. To conclude, a case-based reasoning system can easily be expanded, as expanding a case-based reasoning system amounts to adding new appropriate examples to the set of cases. Expanding a rule-based system on the other hand is much more difficult: adding one rule often means rewriting a large part of the rules.

A major problem in case-based reasoning, however, resides in the retrieval of cases that are sufficiently similar to the new problem at hand. For the purpose of retrieval, a case-based reasoning system uses a similarity measure. Based on the specific measure employed, the system associates a numerical value with each case indicating its similarity to the problem under consideration. The basic idea is that cases with the highest similarity are retrieved from memory. The solutions of the retrieved cases are then combined to create a solution for the new problem. The difficulty is identifying a similarity measure that actually gives high values to cases that are similar to the new problem. Several different similarity measures have been designed, mostly with a specific domain of application in mind. Since these measures are fine-tuned to different problem domains, their performances are not easily compared.

System accuracy can be improved, as referenced in detail herein, by using/integrating an architecture combining rule-based and case-based reasoning. The complementary properties of CBR and RBR can be advantageously combined to solve some problems for which using only one technique fails to provide a satisfactory solution. The architecture may use a set of rules, which are taken to be only approximately correct, to obtain a preliminary answer for a given problem; it then draws analogies from cases to handle exceptions to the rules. Having rules together with cases not only increases the architecture's domain coverage, it also allows innovative ways of doing case-based reasoning: the same rules that are used for rule-based reasoning are also used by the case-based component to do case indexing and case adaptation. CBR processing can also be augmented with rule-based techniques when general domain knowledge is required. For example, adaptation tasks in the CBR processing cycle are usually performed by rule-based systems where the rules capture a theory of case adaptation and the necessary aspect of the domain theory to carry out the changes.

In addition to the knowledge model and the knowledge engine (reasoning approaches), the development of content for the knowledge base may be performed as follows. Initial content development and loading may be performed manually using, for example, cross-industry publications (standards of care 106), collaborative field experience (clinical expertise 108), and/or initial research and development (member records 110). In the context of senior care, for example, the research and development may be built from expert opinions related to geriatric care and directed research activities. Various cross-industry publications, such as The New England Journal of Medicine, The Journal of Aging and Health, The Journal of the American Medical Association, The Gerontologist, etc., may provide the content for a senior care knowledge base.

In at least one embodiment of an information repository of the present disclosure, the information repository may be established through the use of the prototype knowledge management and decision support system described herein. Such a system may collect information from cross-industry publications, collaborative field experience, and/or initial research and development.

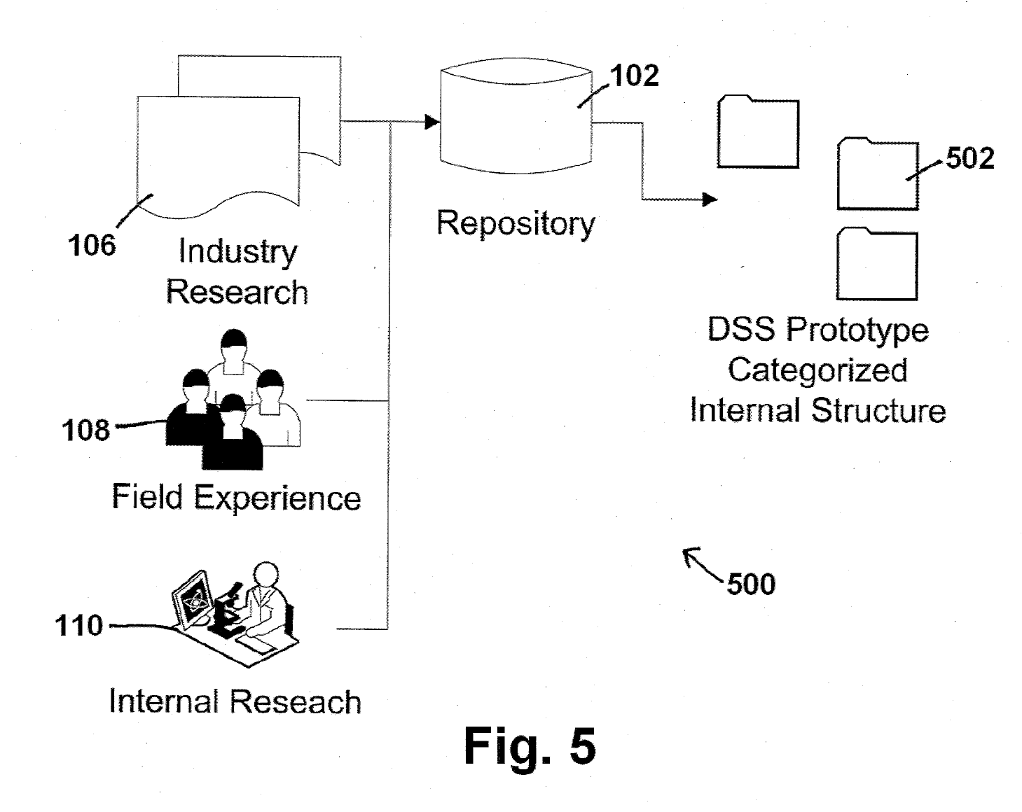

FIG. 5 shows a diagrammatic view of at least a portion of an exemplary system of the present disclosure comprising an evidence repository 102, Evidence repository 102, as shown in the exemplary embodiment of system 500 shown in FIG. 5, comprises evidence from industry research (standards of care 106), field experience (clinical expertise 108), and internal research (member records 110), which may be generally used by DSS Prototype Categorized Internal Structure 502 as referenced herein.

As referenced above, there exists large number of cross industry publications reporting best practices in geriatric care. However, data/information contained in these resources is mostly in the form of free running text, creating a need to rapidly survey the published literature, synthesize, and discover the embedded “knowledge”. Text mining enables analyzing large collections of unstructured documents for the purpose of extracting interesting and non-trivial patterns or knowledge. One type of knowledge that can be discovered from health literature is the commonly encountered issues in geriatric care. The interaction between “issues” and “care practices” may lead to providing better care to geriatric clients as their health conditions dynamically change.

In at least one embodiment of a system and/or method of the present disclosure, an exemplary knowledge discovery algorithm is used to exhaustively search for all “issue-best practice” associations that exist for geriatric care and integrate this knowledge with the knowledge model. Such algorithms differ from those known and/or used by others since the concept terms in application domain are different. In particular, the various algorithms and tools for mining literature as referenced herein involves (i) identifying geriatric care concept (issue) names, (ii) discovering issue-best-practice associations, and (iii) creation of a network of discovered knowledge.

Such an approach may consist of a set of geriatric health care specific databases, a collection of intelligent algorithms for concept tagging, identification and association discovery, and a user interface. A multi-level hybrid approach that incorporates statistical, stochastic, neural network, and NGram models along with multiple dictionaries may be used to handle the multi-object identification and relationship extraction problem.

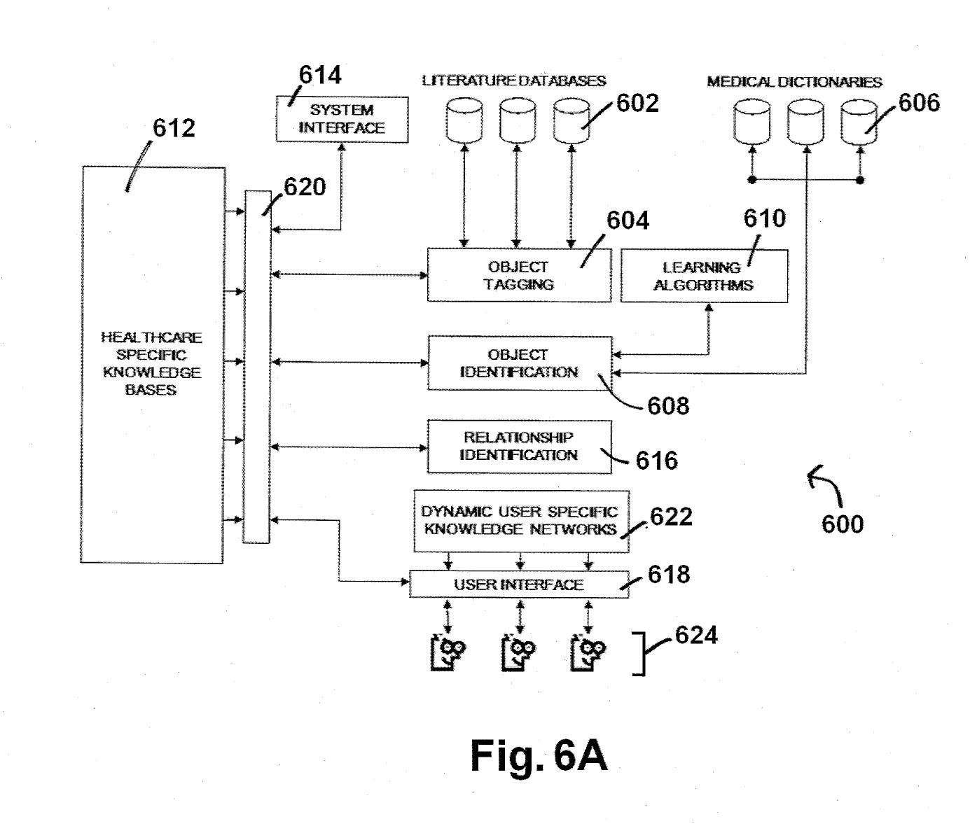

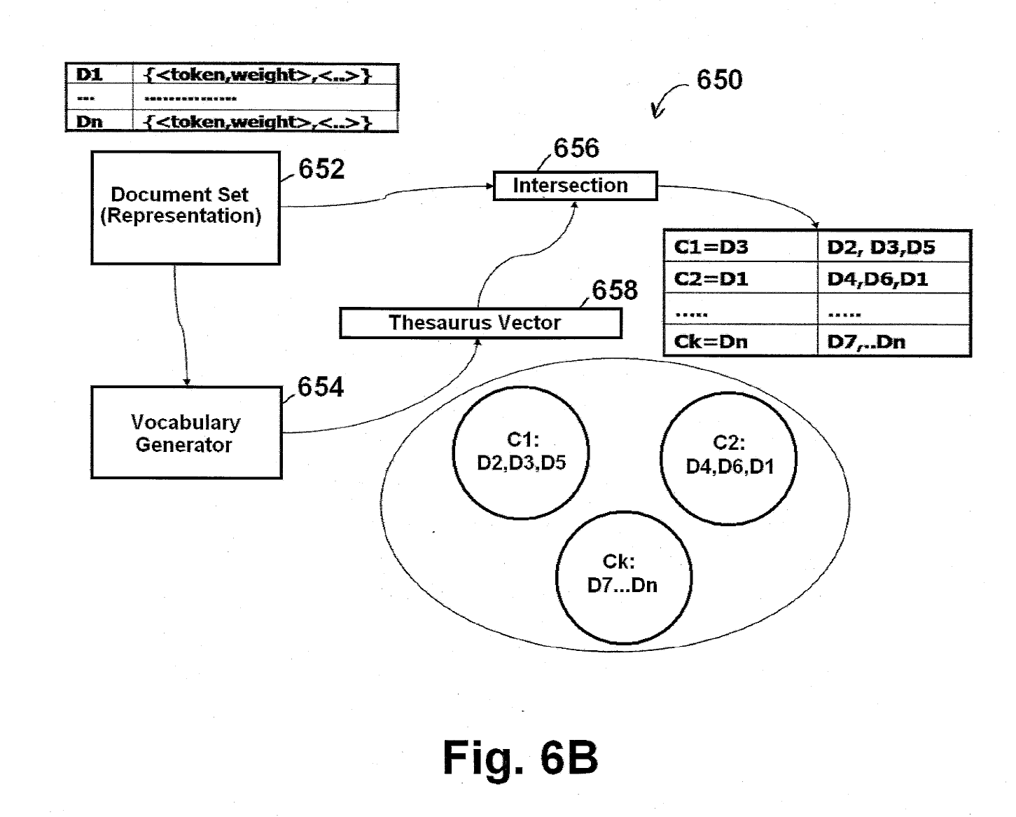

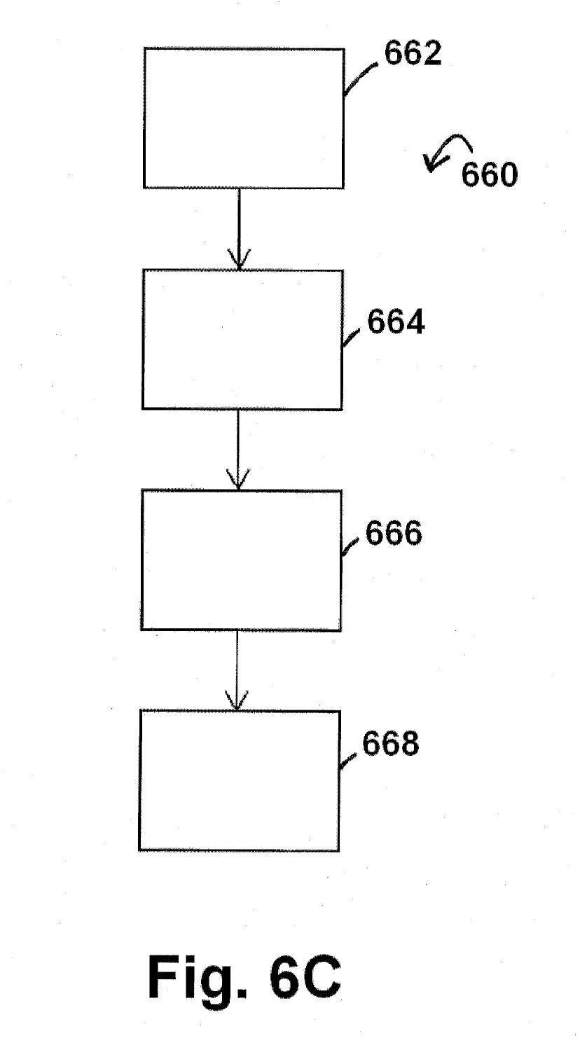

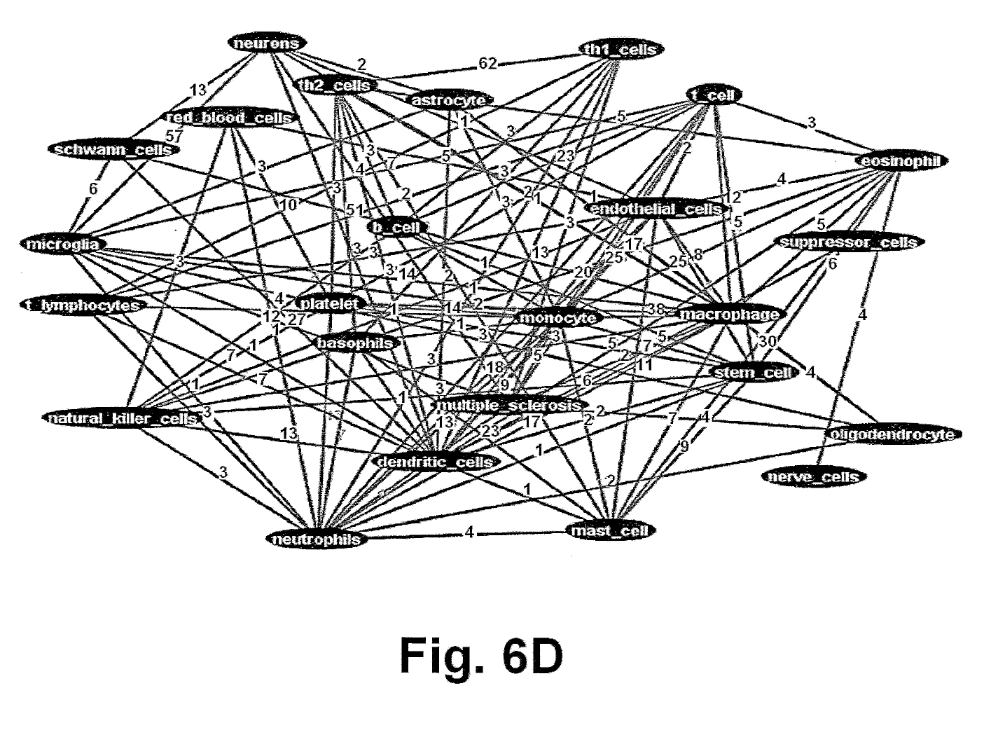

An exemplary architecture for mining literature 600 of the disclosure of the present application is shown in FIG. 6A. As shown in FIG. 6A, architecture for mining literature 600 comprises various literature databases 602 accessible by an object tagging mechanism 604, as well as various medical dictionaries 606 in communication with an object identification mechanism 608. Object identification mechanism 608 may utilize one or more learning algorithms 610 as shown in FIG. 6A, said algorithms 610 useful for concept tagging, identification, and association discovery as referenced herein. Various healthcare specific knowledge bases 612 may communicate with object tagging 604 and object identification 608, and/or various other portions of architecture 600, including system interface 614, relationship identification 616, and user interface 618. Such communication may be made directly from healthcare specific knowledge bases 612, or through medium 620 as shown in FIG. 6A. In addition, user interface 618 may communicate with various dynamic user specific knowledge networks 622, allowing users 624 to benefit from said networks 622 as well as to interface with various portions of architecture 600.

A multi-level hybrid approach that incorporates statistical, stochastic, neural network, and/or N-Gram models, along with multiple dictionaries, may be used to handle the multi-object identification and relationship extraction problem referenced herein.

An exemplary process of discovering associations among health problems and best practice from literature involves retrieving and representing documents from the public domain, content-based clustering of such documents, and detecting co-occurrence of “problems vs. practice” as associations.

An exemplary schematic representation of such a process is shown in FIG. 6B. As shown in exemplary schematic 650, FIG. 6B, D1 . . . Dn represent the documents, and C1 . . . Ck represent the document clusters. Document set 652, as shown in FIG. 6B, communicates with vocabulary generator 654 and intersection 656, while vocabulary generator 654 may itself communicate directly with a thesaurus vector 658 which, in turn, communicates with intersection 656.

An exemplary term discovery module of the present disclosure may automatically build a thesaurus (i.e. a set of key terms) from a collection of documents obtained through a set of key words that was generated in a knowledge modeling process. These terms obtained during the manual process may serve as a keyword search to retrieve a large collection of literature documents. From these documents, further related terms may be automatically generated using the term extraction algorithm that may operate using, for example, a term extraction method 660 using the following steps as shown in the exemplary flowchart shown in FIG. 6C:
1. Identify the unique tokens that appear in each document of the training corpus (Step 662). For each token, also identify the document in which it appears (thus, the same token may appear multiple times in the output list as long it appears in different documents). Remove from the token list commonly appearing terms (e.g. and, or, not, the, etc.) by using a standard stop-word list.
2. Based on all the documents in the training set, calculate the following: the frequency of each unique token in each document, the total number of documents in which each unique token it appears, and the total number of documents in the training set (Step 664).
3. Convert the frequency of each unique token/document to a weight (Step 666). Establish a rank for each unique token in each document according to its weight calculated using said equation. That is, the token with the highest weight in a document receives a rank of 1, the token with the second highest weight in the document receives a rank of 2, and so on.
4. Sort the list of tokens by rank and token (Step 668). Based on the rank and distribution proportion selected by the user, extract the tokens that are ranked between 1-R in at least D documents. A small value of R ensures selection of highly weighted terms, and a relatively large value of D ensures that the same term is highly weighted in significant proportion of the training documents.

Regarding the representation of such documents, and during such an exemplary process, the documents are converted into structures that can be efficiently parsed without the loss of important content. At the core of this process is the thesaurus, an array T of atomic tokens (a single term), each identified by a unique numeric identifier culled from authoritative sources or automatically generated in the document collection from the previous step. A thesaurus may operate as a valuable component in term-normalization tasks and for replacing an uncontrolled vocabulary set with a controlled set. A vector space model attempts to compute the importance of terms on the basis of term frequencies within a document and within an entire document collection. The tf*idf (term frequency multiplied with inverse document frequency) algorithm is used for calculating term weights. Thus, each document vector consists of tf*idf weight of the terms in the dictionary given by the following formula:

$${W}_{ik} = {T}_{ik} * {I}_{k} = {T}_{ik} * log ( \frac{N}{{n}_{k}} ) \qquad [ 1 ]$$

wherein Wᵢₖ is the weight of occurrences of term Tₖ in document i, Tᵢₖ is the number of occurrences of term Tₖ in document i, Iₖ=log(N/nₖ) is the inverse document frequency of term Tₖ in the document set, N is the total number of documents in the document set, and nₖ is the number of documents in the set that contain the given term Tₖ. The document vector is a weight vector whose size is the same as the number of terms in the dictionary and whose elements are the if*idf weights of the corresponding terms.

Regarding content-based document classification, such a process may consist primarily of two stages, namely an unsupervised cluster learning stage and a vector classification stage. These may be conducted in a batch mode to autonomously discover/learn classes. During this learning stage, initial cluster hypotheses [C¹, . . . , C^{k}] are generated from a representative sample of document vectors [V¹, . . . , V^{N}]. Each cluster C¹ is then represented by its centroid, Zⁱ. The set of cluster centroids Zⁱ forms a classification scheme used during the actual filtering mode. Semantically, the scheme can be viewed as a high level grouping of concepts so that they form sub-areas or classes in the domain covered by the thesaurus.

Each element in the vector Zⁱ represents a particular token identifier in the thesaurus. The dimension of Zⁱ equals the number of unique token identifiers in the thesaurus. A simple heuristic unsupervised clustering algorithm called the Maximin-Distance algorithm, is used to determine the centroids over the document vector space. The measure used for computing the distance between two document vectors is the cosine similarity measure. More specifically, given two document vectors, X=[xᵢ] and Y=[yⱼ], their similarity is given by

S_{xy}=Σxᵢyᵢ/\sqrt{Σxᵢ²}·\sqrt{Σyᵢ²} [2]

and the distance is given by d_{xy}=1−S_{xy}.

The goal of the classification process is to cluster documents into different thematic contents. Documents in each cluster may then be further processed to discover associations between semantic terms. The document vectors will be used for extracting the associations. Using the document vector representation, a method is described to find object-object association. An exemplary goal is to discover a pair of objects from a collection of documents such that the objects in each pair are associated in some manner. For example, one may consider both the relative “importance” of each entity as well as the strength of their joint occurrences to find biological associations. Once the documents are represented using a vector space model, the association between the two object terms k and l may be computed as follows:

$$\begin{matrix}association [ k ] [ l ] = {\sum }_{i = 1}^{n} {W}_{ik} * {W}_{il} & k , l = 1 … m\end{matrix} \qquad [ 3 ]$$

wherein n is the total number of documents and m is the number of objects in the document vector, Wᵢₖ denotes the weight of the k^{th} object term. The computed association value is used as a measure of the degree of relationship between the k^{th} and l^{th} object terms, resulting in an association matrix. For any pair of object terms co-occurring in even a single document, the association [k][l] will be non-zero and positive. The association matrix is a symmetric matrix, and the non-zero and non-diagonal values from the matrix are used for creating the explicit binary association network.

Such discovered associations can then be represented and visualized as a graph as shown in FIG. 6D. The association graph shown in FIG. 6D shows, for example, associations discovered for various biological documents using systems and methods of the present disclosure.

The key innovative features of various approaches referenced herein are that they are adaptable and scalable, and that the core knowledge base will be extracted from past and recent best practice outcomes reported in the literature. The scalability feature allows the various systems to continue to develop their respective knowledge base(s) as new information arrives in the literature databases or by incorporating information from other data sources.

Regarding validation of system outcomes, evaluation (as referenced herein) is the act of measuring or exploring properties of a health information system (in planning, development, implementation, or operation), the result of which informs a decision to be made concerning that system in a specific context. Iterative cycles of design and evaluation at all stages in the development of various systems of the present disclosure, with refinements based on the results of the evaluations, are useful in connection with system development and implementation. Such a validation is based on the evaluation of real world outcomes resulting from interventions recommended by, for example, SCANS 104. Evaluation is the act of measuring or exploring properties of a health information system (in planning, development, implementation, or operation), the result of which informs a decision to be made concerning that system in a specific context.

Interactive cycles of design and evaluation at all stages in the development of SCANS 104, for example, with refinements based on the results of the evaluations, have been instituted for system development and implementation. In order to improve quality and safety, such a system may be evaluated in the actual setting using both quantitative and qualitative evaluation methodologies to assess multiple dimensions and design (e.g., the correctness, reliability, and validity of the knowledge base, the congruence of system-driven processes with care management roles, and work routines in care management practice).

Effectiveness of the various systems of the present disclosure include may be determined based upon several attributes, including (i) simplicity (referring to structure and ease of operation), (ii) flexibility (whereby the developed systems adapt to changing information needs or operating conditions with little additional cost in time, personnel, or allocated funds, thereby allowing for iterative modification in response to changes in practice based knowledge), (iii) acceptability (reflecting the willingness of case managers to provide accurate, consistent, complete, and timely data on a system's performance and its compatibility with legacy applications), (iv) sensitivity (considered at two levels, including system evaluation for its ability of detection of unintended effects and evaluation for the ability to stratify the patient population to whom the system effectively improves health and/or quality of life), (v) Predictive Value Positive (PVP, relating to sensitivity and is the proportion of members identified by the system(s) as needing the intervention and those effectively benefiting from the intervention), (vi) representativeness (noting that a system that is representative accurately describes the occurrence of the evidence and its distribution in the population, with consideration given to the comparability of categories (e.g., race, age, residence, disease status, mental ability) on which the numerators and denominators of rate calculations are based), and (vii) timeliness (reflecting if the case managers' performance represents the current accepted standards in care for well-timed suitable intervention).

In a geriatric care context, the identification of various care categories to facilitate the convenient collection of review of, and access to corresponding patient information represents at least one focus of the disclosure of the present application. By way of example, at least twenty-five (25) care categories have been identified as disclosed below:

| Care Category | Explanation |
|---|---|
| Immediate Concerns | Addresses solutions and actions for identified risks that |
| | are affecting safety, health, and well-being of the |
| | member. |
| Information Management | Assists the member and/or member unit in collecting and |
| | organizing the following information to complete the |
| | Personal Health Care Record: Emergency Contact |
| | Information, Personal Health History, Personal Physician |
| | Care Plans, Insurance & Health-Related Legal |
| | Information including Advance Directives, and |
| | Assessment Results & Recommendations. |
| Provider Coordination | Identifies areas to improve communication between |
| | member and providers. Assists in providing solutions and |
| | actions to improve communication between providers and |
| | the member and/or providers and providers. |
| Service Coordination | Addresses areas in which the member may require |
| | additional supportive services. Assists the member and/or |
| | member unit in obtaining and managing quality services, |
| | e.g. companion services, lawn services, home care, etc. |
| Medication Management | Assists with the identification of current prescribed, |
| | routine, PRN, and OTC medications. Reinforces the |
| | member adherence to physician directed medication |
| | regimen. |
| Financial | Assists the member and/or member unit in obtaining |
| | financial and legal advice regarding the development of a |
| | financial plan which both protects the member's assets |
| | and meets the member's ongoing health and long term |
| | care needs. |
| Insurance | Assists the member and/or member unit in evaluating |
| | their health and long term care insurance coverage with |
| | the goal of being current, complete, and reasonably |
| | priced. |
| Legal | Assists the member and/or member unit in understanding |
| | the definitions of, and need for, advance directives, living |
| | will, and durable power of attorney. Provides solutions |
| | and actions to assist the member with the designation of a |
| | durable power of attorney for health care. Provides the |
| | member with solutions and actions for completing funeral |
| | arrangements. |
| Caregiver Support | Provides the member unit with options/solutions to assist |
| | them in developing effective coping skills when dealing |
| | with the physical, emotional, and financial burdens of |
| | caregiving. |
| Communication | Provides options/solutions to assist the member and/or |
| | member unit improve communication and monitor their |
| | success. |
| Physical Health | Assists the member and/or member unit in identifying |
| | appropriate information, resources, activities, and |
| | services for improving physical health status. |
| Functional Health | Identifies opportunities for improvement in achieving |
| | maximum independence. Assist the member in |
| | identifying solutions and/or actions to maximize his/her |
| | abilities in Activities of Daily Living and Independent |
| | Activities of Daily Living (ADL's/IADL's). |
| Sensory | Identifies solutions and actions for improvement |
| | opportunities regarding sensory needs; e.g. hearing and |
| | visual deficits. |
| Continence | Identifies solutions and actions for improvement |
| | opportunities in managing and implementing |
| | incontinence treatment plans as instructed by the |
| | providers. |
| Pain | Identifies solutions and actions for improvement |
| | opportunities in managing and implementing chronic pain |
| | management plans as defined by the provider. |
| Nutritional | Identifies solutions and actions for improvement related |
| | to the need for proper nutrition for optimal health and |
| | well-being. |
| Cognitive | Provides information, education, and/or referral to |
| | services addressing cognitive decline. Identifies |
| | resources to maximize caregiver support. |
| Behavioral | Provides information, education, and/or referral to |
| | services addressing behavioral health concerns. Identifies |
| | resources to maximize caregiver support. |
| Emotional | Provides information, education and/or referral to |
| | services addressing emotional concerns. Identifies |
| | resources to maximize caregiver support. |
| Social | Identifies and mobilizes social resources and support |
| | systems, |
| Intellectual | Identifies solutions/actions to maintain/improve |
| | intellectual well-being by providing information, |
| | education, and/or referral to services. |
| Environmental | Identifies environmental and safety risks. Provides |
| | options/solutions to assist toward improved |
| | environmental, and safety issues. |
| Spiritual | Identifies and mobilizes spiritual resources and support |
| | systems. |
| Prevention | Assists member in understanding prevention |
| | recommendations based on their age, gender, and risk |
| | factors. Identifies appropriate information, resources, |
| | activities, and services to implement the preventative |
| | recommendations. |
| Wellness | Identifies appropriate information, resources, activities, |
| | and services for improving overall well-being. |

In an exemplary embodiment of a system of the present disclosure, a multi-dimensional health assessment examining seventeen (17) areas with hundreds of data elements and measures may be utilized by a HCM, with the goal of the assessment is to evaluate and promote overall well-being of the older adult. In at least one embodiment, seven of the aforementioned dimensions are health specific and ten are dimensions surrounding and affecting physical health (such as social support, emotional status, and residential safety).

In an exemplary multi-dimensional health assessment of the disclosure of the present application, the assessment comprises the following dimensions:
1. Demographic: Collects general demographic information including but not limited too the member's current living and marital status; accessibility to bathroom, bedroom, and laundry; and work/volunteer history.
2. Family: Identifies family members deceased and living. Provides family health history and availability.
3. Social support: Addresses the family's/friends' level of support, identifies communication techniques and the member's engagement in social activities.
4. Representatives/Key Contacts: Lists individuals that the member has identified to have permission to health and/or financial information, including the level of information they may access and the manner in which the information can be shared.
5. Financial: Identifies the member's perception of his/her financial needs and if additional assistance is required.
6. Spiritual: Acknowledges the member's perception of his/her spiritual needs and level of comfort/peace with current health status.
7. Legal: Addresses whether the member has arranged for an individual to act on his/her behalf. Evaluates the status of the member's advance directives, funeral, and/or burial/cremation arrangements.
8. Insurance: Assesses the need for an insurance review and continued education.
9. Support Services: Identifies the multiple service providers and assesses the level of communication between the providers.
10. Caregiver Support: Recognizes the stress level and needs of the caregiver.
11. Physical Health: Addresses the member's past medical history and current health status, capturing chronic illnesses, chronic pain, incontinence, weight loss/gain, nutritional status, and sleep habits.
12. Functional Health Status: Captures the member's perception of and satisfaction with his/her health status while assessing the member's physical functional status including activities of daily living, balance, ambulation, assistive devices, and sensory status.
13. Emotional/Psychological: Assesses the cognitive, emotional, and behavior status of the member. Screens for cognitive impairment, anxiety, depressive symptoms, and substance abuse.
14. Medication History: Identifies multiple providers, multiple pharmacies, allergies, polypharmacy, and medication administrative needs.
15. Home/Residential Environmental & Safety Assessment: Provides a visual assessment of the member's environment. Addresses, fall risk, elder abuse, disaster plan, fire/burn prevention, crime/injury, injury prevention, communication system, and support network.
16. Health Prevention: Addresses if the member is following the preventative recommendations and attending health screening activities.
17. Wellness: Assesses the member's understanding of activities that promote improved health status such as wellness classes, tobacco use cessation, and/or intellectual stimulation.

Such multi-dimensional health assessment, for example, can provide a sufficient case model against which a system of the present disclosure, including but not limited to SCANS 104, can “reason.”

In addition to the aforementioned assessment dimensions, there may be additional information HCMs can gather which will improve the efficacy of recommended solutions. One such example may be to assess member readiness looking at two new scales. Exemplary scales may include the following:
1. Activity (T, ranging from 1 to 5): the level of involvement and willing participation the senior has in compliance, response, and feedback with the Health Care Manager
2. Activism (S, ranging from 1 to 5): the interest and proactivity the senior has in understanding his or her condition, searching for more information, and interacting knowledgeably with health providers

Recommendations from SCANS 104, for example, may be improved taking these scales under consideration. The high T low S “Compliant Member” is likely to respond differently to particular interventions than the “Partner Member” scoring high on both scales.

SCANS 104, or any other knowledge management and decision support system 104, is only as effective as its underlying knowledge base, which changes rapidly as the health care science (or any other field of art in connection with a knowledge management and decision support system 104) evolves. The knowledge management and decision support systems 104 of the present disclosure not only evidence-based, but they are also evidence-adaptive, potentially utilizing automated updates to reflect changes in health sciences and local practices. Usage of such a knowledge management and decision support system 104 may lead to several practical goals, including (1) improvement and/or stabilization of member outcomes including self-management of disease(s), functional status, effective health service utilization, and satisfaction with services, (2) improvement of HCM outcomes such as perceived workload, work pressure, job satisfaction, and autonomy, and (3) an improved cost/utility ratio.

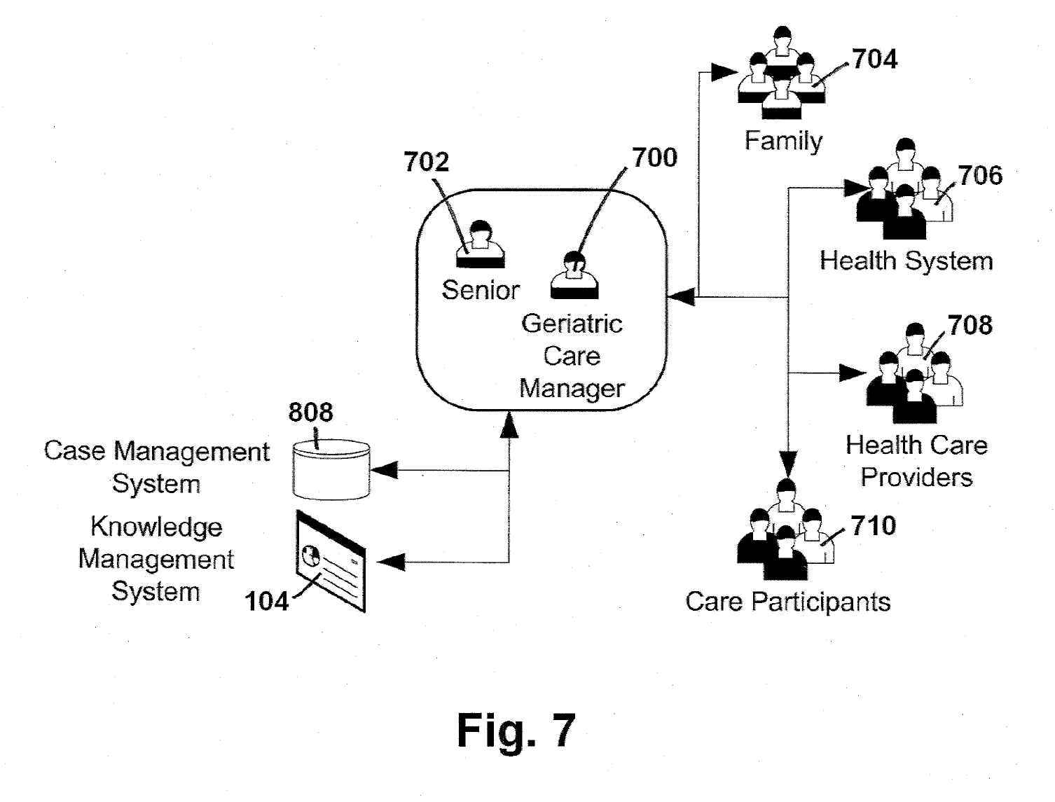

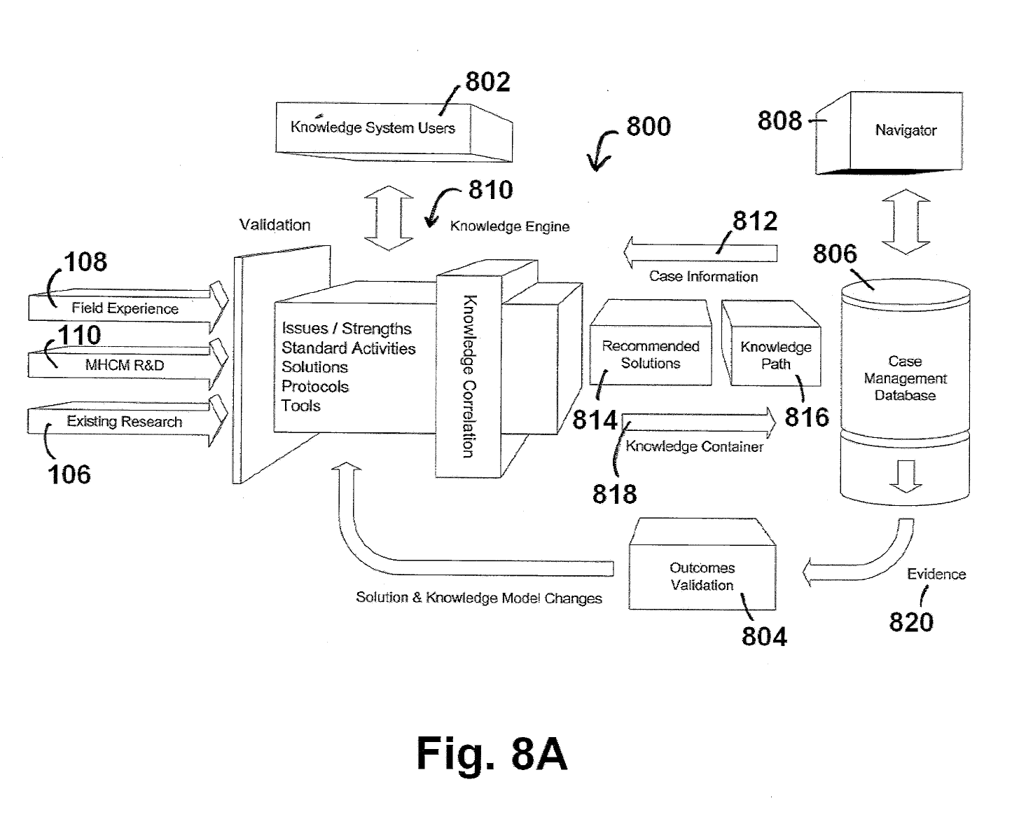

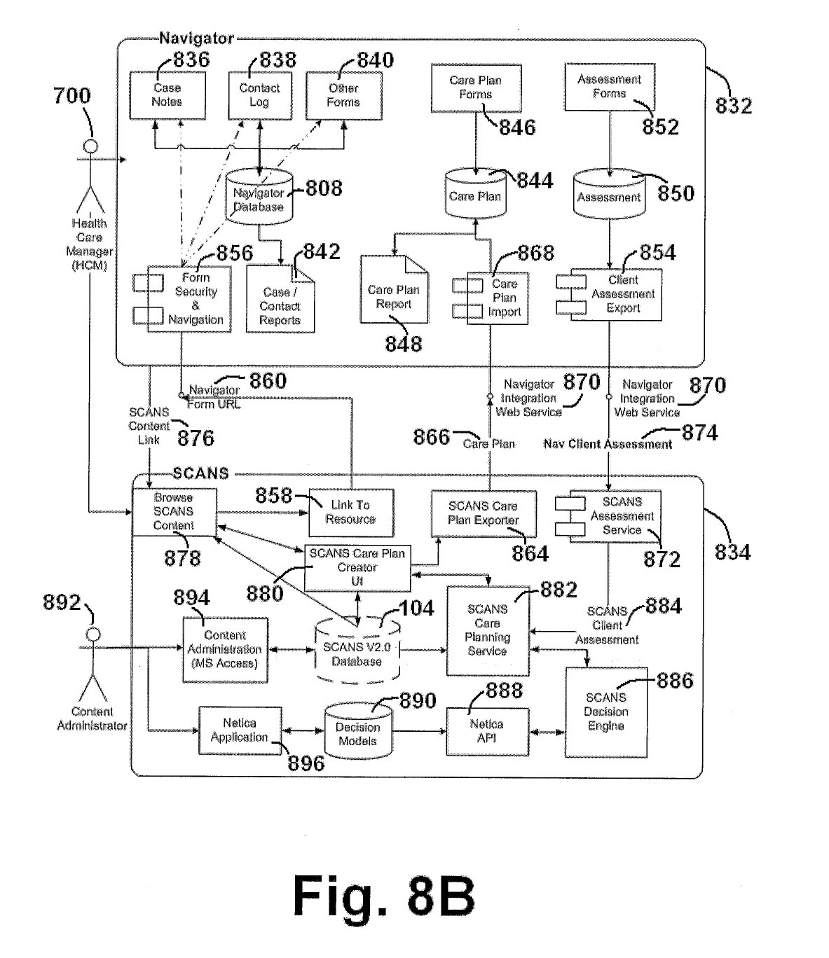

Various individuals may benefit from and/or provide knowledge/input to one or more system of the present disclosure as shown in FIG. 7. As shown in FIG. 7, and in an exemplary senior care context, a knowledge management and decision support system 104 (also referenced as SCANS 104 within the present disclosure) and a case management system 808 (as referenced in FIG. 8A, also referred to as “Navigator”) may be used by, for example, geriatric care managers 700 (GCMs, also referenced to herein as HCMs or users) to help facilitate, advocate, coordinate, and/or educate seniors 702 and their families 704 on the issues and options of aging. Much of this work may involve direct communication and/or intervention with various aspects of a health system 706 (including, but not limited to, insurance services, hospital services, and ancillary services), as well as health care providers 708 (including, but not limited to, doctors, therapists, and the like) and other care participants 710 (including, but not limited to, home helpers, home modification contractors, companions, etc.).

GCMs 700, for example, may utilize case management system 808, which, in an exemplary embodiment, may support the assessment, planning, implementation, and tracking of care. GCMs 700 may also utilize a knowledge management and decision support system 104 which provides consistent, complete care guidance and best practices. SCANS 104 (an exemplary knowledge management and decision support system 104) may provide “real world solutions” and practical hands-on resources and tools to GCMs 700 for implementation as referenced herein. SCANS 104, for example, represents and traverses information in a complex decision network, with the various parts of the decision network connected to other parts with functional dependencies, priorities, risk valuations, weightings, and threshold constraints. Validation of various results in small and large scale studies examining the efficacy of both the solutions implemented and knowledge traversal will be made possible by SCANS 104.

An exemplary SCANS summary architecture 800 of the disclosure of the present application is shown in FIG. 8A. As shown in FIG. 8A, exemplary architecture 800 comprises five sources of knowledge, including (i) field experience (clinical expertise 108), (ii) MHCM (acronym for My Health Care Manager) R&D (member records 110, also referred to as “internal research” herein), (iii) existing research (standards of care 106, also referred to as “industry research” herein), (iv) knowledge system users 802, and (v) outcomes validation 804. As referenced herein, field experience (clinical expertise 108) may comprise practical knowledge and resources developed by direct contact/service with clients, and MHCM R&D (member records 110) may comprise direct research and tool development in particular areas of concern to, for example, clients, geriatric care managers, and the senior care industry. Existing research (standards of care 106) may comprise information from the vast body of medical, health, and psychosocial literature where part or all of a particular publication may be relevant to geriatric care. Knowledge system users 802 may provide knowledge available from direct interaction with one or more systems of the present disclosure related to the applicability, priority, and confidence of interventions recommended by the one or more systems. Outcomes validation 804 may comprise knowledge resulting from analysis of real-world results of recommended interventions.

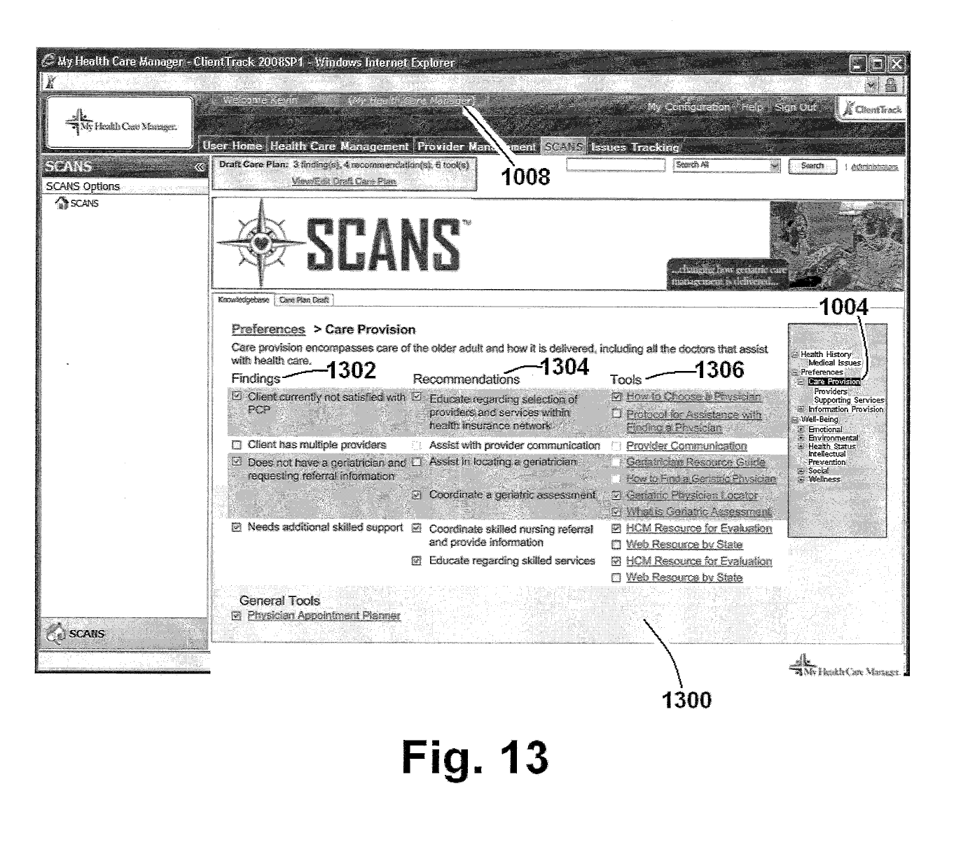

As referenced in connection with the exemplary architecture 800 shown in FIG. 8A, the standards of care 106, clinical expertise 108, and member records 110 may be useful to establish an initial knowledge repository used in one or more systems of the present disclosure (including SCANS 104, for example), and may be useful to provide information for various findings 1302, recommendations 1304, and tools 1306 (as referenced in FIG. 13, for example), and their corresponding issues, strengths, standard activities, solutions, and protocols, as applicable. These three sources of knowledge may also provide the relationships useful to support knowledge correlation and automated reasoning as referenced within the present disclosure.

In at least one embodiment, the knowledge from knowledge system users 802 and outcomes validation 804 may be useful to improve the overall knowledge base of one or more systems of the present disclosure. In addition, automation techniques may be utilized to speed the acquisition, analysis, and validation of each of the aforementioned sources of knowledge on an on-going basis, which is intended to ultimately provide, for example, the timeliest and most complete knowledge repository available for the particular field.

As shown in the exemplary architecture 800 shown in FIG. 8A, architecture 800 comprises a case management database 806 in communication with a case management system 808 (referenced as “Navigator” in the figure), whereby a knowledge engine 810 uses knowledge from the aforementioned five sources of knowledge, the case management system 808, and various case information 812 to provide recommended solutions 814 (also referred to as “interventions”). Such information may then be returned to the case management system 808 for care planning and storage. Furthermore, any necessary and/or desired information about knowledge path 816 or a reasoning process may be included with the recommended solutions 814 in a knowledge container 818 and retained for future analysis. As shown in FIG. 8A, evidence 820 may be collected in the form of intervention acceptance and results from outcomes validation 804 and overall improvement of the knowledge model.

Knowledge engine 810 represents and traverses information in a complex decision network, with the various parts of decision network connected to other parts with functional dependencies, threshold constraints, weightings, risk valuations, and priorities. For example, when knowledge engine 810 is seeking solutions to a particular issue area like medication management, other conditions and paths in the network should/must be considered. In an older adult (senior 702) is struggling with the physical management of medications, the use of a pill tray may be a practical solution. However, other conditions may influence such a recommendation, as, for example, if the senior's 702 visual acuity is diminished, a pill tray may be an ineffective recommendation and may even increase the risks of medication errors. When other conditions reach a critical threshold, they may alter recommendations as well. Continuing the example, if the senior 702 struggling with medications is slightly depressed, there may be little impact on medication management recommendations. However, if the senior 702 reaches a serious level of depression, recommendations may change dramatically, and self-management techniques may need to be dropped in favor of in-home medication management services.

Recommended solutions themselves are subject to a variety of weighting factors. For example, the source of a particular recommendation may affect its ranking. Results from a recognized study may likely outweigh a handful of anecdotal positive results from field experience. These factors change over time, however, as solutions are used in real world application and as new research and study data are reported. Some solutions may even have risks that must be weighed as part of the recommendation process. Someone with balance problems may want to consider carefully the benefits of a particular physical activity. Likewise, the preferences of the older adult and priorities of the family may influence recommendations.

Many older adults will have far more issues than can effectively be addressed at one time. Choosing items of priority to the older adult and to caregivers will improve the likelihood of both adoption and success.

An exemplary system architecture of the present application is shown in FIG. 8B. As shown in FIG. 8B, system architecture 830 shows the relationship between an exemplary case management system architecture 832 and a knowledge management and decision support system architecture 834. As shown in FIG. 8B, case management system 808 (shown as Navigator) is in communication with various case notes 836, contact logs 838, and other forms 840 applicable to case management system architecture 832. Case management system 808 may operate to generate one or more case/contact reports 842, including information from various case notes 836, contact logs 838, and/or other forms 840. In addition, case management system architecture 832 may comprise a care plan module 844, operable to obtain information from care plan forms 846 and/or generate one or more care plan reports 848, and an assessment module 850, operable to obtain information from assessment forms module 852 and/or generate one or more client assessment exports 854.

Case management system architecture 832 may interface with knowledge management and decision support system architecture 834 in several ways. For example, and as shown in FIG. 8B, form security & navigation 856 may provide information to various case notes 836, contact logs 838, and/or other forms 840, but also interface with knowledge management and decision support system architecture 834 via a link to resource 858 via, for example, a form URL 860. In addition, a care plan exporter 862 within knowledge management and decision support system architecture 834 may provide care plan information 866 to care plan import 868 within case management system architecture 832 via, for example, integration web service 870. Furthermore, client assessment export 854 within case management system architecture 832 may interface with assessment service 872 within knowledge management and decision support system architecture 834, providing client assessment information 874 via, for example, integration web service 870. In addition, case management system architecture 832 and knowledge management and decision support system architecture 834 may interface with one another via content link 876 to browse content 878. GCM 700, as shown in FIG. 8B, may access both the exemplary case management system architecture 832 and the knowledge management and decision support system architecture 834.

The exemplary knowledge management and decision support system architecture 834 shown in FIG. 8B may itself include a number of components, including care plan creator 880 and care planning service 882. Care plan creator 880 may serve as a user interface to care plan exporter 864, whereby information from SCANS 104 may be used to create a care plan 866 which is exported to case management system architecture 832 by way of, for example, care plan exporter 864. Care planning service 882 may receive one or more client assessments 884 from assessment service 872, and may also interface with decision engine 886 when performing its own function using one or more client assessments 884. Application programming interface 888 may receive information from decision models module 890 and may also share information with decision engine 886 as shown in FIG. 8B. A content administrator 892 may access knowledge management and decision support system architecture 834 and its related components by way of content administration interface 894, which communicates with SCANS 104, or application 896 which communicates with decision models module 890.

Automating Knowledge Acquisition for Bayesian Networks

As introduced above, a Bayesian network (BN) is a directed acyclic graph whose arcs denote a direct causal influence between parent nodes (causes) and children nodes (effects). A BN is often used in conjunction with statistical techniques as a powerful data analysis tool. While it can handle incomplete data and uncertainty in domain, it can also combine prior knowledge with new data (evidence).

A BN makes predictions using the conditional probability distribution tables (CPT). Each node in a BN has a CPT which describes the conditional probability of that node, given the values of its parents. Using the CPT for each node, the joint probability distribution of the entire network can be derived by multiplying the conditional probability of each node.

Probabilistic inference in a Bayesian network is achieved through evidence propagation. Evidence propagation is the process of efficiently computing the marginal probabilities of variables of interest, conditional on arbitrary configurations of other variables, which constitute the observed evidence.

There are at least two approaches to construct a BN, namely knowledge-driven and data-driven. The knowledge-driven approach involves using an expert's domain knowledge to derive the causal associations, and the data driven approach derives the mappings from data which can then be validated by the expert.

BNs can be used to model causal relations, which, in some instances, may be essential in understanding the problem domain and predicting the consequences of an intervention. Causality denotes a necessary relationship between one event (“cause”) and another event (“effect”) which is the direct consequence of the first. It implies a dependency between a cause and an effect where the probability of the “effect” occurring becomes very high, if the “cause” occurs first in a chronological order.

A causal model is an abstract model that uses cause and effect logic to describe the behavior of a system. Causal associations can be mined from text using various approach including lexico-syntactic analysis. Based on such a model and/or the causal associations, a BN may be developed.

Several modeling issues in this transformation may be addressed. For example, a causal map depicts causality between variables, implying dependence between those variables. Hence, it is referred to as a “D-map”. BNs, on the other hand, are “I-maps”—given a sequence of variables, an absence of arrow from a variable to its successors in the sequence implies conditional independence between the variables. Other modeling issues include the elimination of circular relations, the reasoning underlying the link between concepts, and the distinction between direct and indirect relations

Mining causal associations from text using lexico-syntactic analysis has been studied in previous work. For example, one method was developed for automatic detection of causation patterns and semi-automatic validation of ambiguous lexico-syntactic patterns that refer to causal relationships. This procedure requires a set each of causation-verbs and nouns frequently used in a given domain. Using these sets, all patterns of type <NP1 cause_verb NP2>, for example, where NP1 and NP2 are noun phrases, can be extracted. Some of the causal verbs found to be the most frequent and less ambiguous include “lead (to)”, “derive (from)”, and “result (from)”, for example. Applying some of the causal patterns identified by such a system may, for example, result in the following example: “Anemia are caused by excessive hemolysis”, “Hemolysis is a result of intrinsic red cell defects”, and “Splenic sequestration produces anemia”. The networks of the present disclosure differ from previous work in that the present inventive efforts design a general framework for building a Bayesian network based on text mining. Such a complex process may be divided into several stages.

Regarding a probability assessment, one may assume, for example, that by using the existing techniques, causal associations are extracted and available in the following format:
Noun phrase1|Causal verb|Noun phrase2|Probability|Evidence level

Noun phrase1, Causal verb, and Noun phrase2, in the present example, are the triplet mined from text using techniques mentioned above. Probability is the prior probability for the causal mapping, which can be extracted from text using additional semantic analysis or assigned a default value. Evidence level refers to a categorization or ranking of the evidence, required to compute a “confidence” measure for the mined causal mapping. This is a domain specific qualification of the evidence. For example, evidence-based medicine categorizes different types of clinical evidence and ranks them according to the strength of their freedom from the various biases that beset medical research. It also lists some commonly used evidence categories.

By way of example, the sentence: “For persons age 65 and older, 25% of falls result in fracture” can be decomposed into the following:
falls | result in | fracture | 0.25 | Level 1

When the associations are extracted, an expert is subjected to a structured interview to resolve the biases in the causal maps or given an adjacency matrix representation of the associations to specify the relations. Known direct response-encoding methods to derive probabilities for the causal associations may be used, whereby a subject responds to a set of questions either directly by providing numbers or indirectly by choosing between simple alternatives (or “bets”). These are manual encoding techniques and require the knowledge and judgment of a human subject to elicit probabilities. It may, however, be possible to develop an automated technique to augment these manual encoding procedures. The aim of such a technique is to search for and utilize numerical data accompanying the sentences containing the causal associations and present it to the expert.

Percentages are a common way of summarizing a statistical result. Sentences containing a causal association might also contain percentages from surveys and experiments to emphasize the relation. Hence, it may be useful to examine sentences marked as containing causal associations for numerical details, which can yield statistical data for the BN.

It can be observed that a percentage usually occur in close proximity of the noun phrases, which are part of a causal relationship. Simple sentential structures may include, for example:

<numerical_string_post NP1 causal_verb NP2>
<NP1 causal_verb NP2 numerical_string_post>
Where:
numerical_string_post, numerical_string_post can be “xx%”,
“xx% of”, “xx% of the times”, etc.

For example, “20% falls lead to death”, “5% of people who fall require hospitalization”, “25% of the time fall can result in fracture”, “Falls can result in fracture 25% of the times”, etc., may follow the aforementioned structure. These percentage values, for example, can then be directly converted to the probability value for that assertion.

The strength of a causal association in text can also be estimated by looking for superlatives and other phrases which qualify the verb. For example, and in the elder care context, “There is a strong possibility that falls result in fracture”. A list of such phrases can be mapped to pre-defined probability values.

While such patterns yield the probabilities or causal strength of the relations, other intra-sentential patterns might yield prior-probabilities for nodes in a BN. For example: “In the age 65-and-over population as a whole, approximately 35% to 40% of community-dwelling, generally healthy older persons fall annually.” This sentence would yield the prior probability for a continuous-valued node for ‘age’ in a BN for ‘fall risk’, a prior probability of 0.375 (average), when the age of the person is 65 years or greater.

With respect to estimating the evidence level, such efforts may require keyword search and/or semantic analysis of the document title, abstract, conclusion and the segment of the text containing the sentence with the causal associations. For example, in geriatric evidence based practice, levels of quantitative evidence from 1 to 6 may be provided in descending order of importance. Documents containing a level-2 evidence usually have the string “Randomized Control Trial” mentioned either in their title, abstract or keywords section.

A domain expert may then need to pre-define a mapping of the evidence level to a value between [0, 1], which can be used in a formula to compute the confidence measure. After the probabilities have been extracted and assessed, an attempt to determine how much confidence there is in the causal associations mined from text can be made. The confidence measure is a score associated with most or every causal mapping in the BN based on the confidence we have in asserting that relationship. It is an attempt at quantifying the confidence placed in the causal relationship uncovered by automated methods.

In this respect, two primary parameters to consider are a measure of a journal's influence measure, for example, and the evidence level of the evidence itself. Various measures have been suggested for measuring a journal's influence, including the Institute for Scientific Information (ISI) Impact Factor and Eigenfactor. The impact factor, often abbreviated IF, is a measure of the citations to science and social science journals. It is frequently used as a proxy for the importance of a journal to its field. The impact factor of a journal is calculated based on a two-year period. It can be viewed as the average number of citations in a year given to those papers in a journal that were published during the two preceding years.

For example, the 2003 impact factor of a journal would be calculated as follows:

IF=A/B [4]

wherein A represents the number of times articles published in 2001-2 were cited in indexed journals during 2003, and B represents the number of “citable items” published in 2001-2.

PageRank is a link analysis algorithm used by the Google Internet search engine that assigns a numerical weighting to each element of a hyperlinked set of documents. The algorithm may be applied to any collection of entities with reciprocal quotations and references, such as articles published by a journal. A version of PageRank has been proposed as a replacement for the ISI impact factor, called Eigenfactor. In this measure, journals are rated according to the number of incoming citations, with citations from highly-ranked journals weighted to make a larger contribution to the Eigenfactor than those from poorly-ranked journals.

A third way to perform such a task would be for a domain expert to manually assign influence measure for the journals in the domain. However, such a process is not only time consuming, but could also be tedious for domains which have a large number of publishing journals. Moreover, the task of keeping this measure updated also becomes very tedious.

In at least one method of performing such a task, the final choice of the influence measure may depend on the domain expert. In an exemplary embodiment, the chosen influence measure for the domain is normalized to a value [0, 1] for every journal. The confidence measure (CM) is then computed as a weighted average of these two parameters (influence measure (IM) and evidence level (EL)):

CM=((W_{—}i*IE)+(W_{—}e*EL))/(W_{—}i+W_{—}e) [5]

In this example, W_i and W_e are the weights assigned to influence measure and evidence level, respectively. W_i and W_e can be determined at the expert's discretion and could vary from domain to domain.

As mentioned earlier, certain modeling issues need to be resolved while converting causal maps into BNs. Two of the most widely used methods are structured interviews and adjacency matrices. In structured interviews, experts are provided a list of paired concepts as well as different alternative specifications of the relation between the concepts in the original map and asked to choose an alternative to specify the direct relation between the pair of concepts. Using adjacency matrices, the experts are asked to specify for each cell, whether it is a positive, negative or null relation. However, and according to the present inventive disclosure, additional details are provided to the expert in the form of suggestions for node mapping, loop handling, choosing between direct and indirect relations and values for probabilities in the light of new data.

1. Mapping noun phrases to nodes in a BN: Mapping the mined noun phrases to a node in the existing BN is a semantic classification problem and can be solved using one of the existing information retrieval and/or classification techniques. Using k-nearest neighbor (k-nn) technique, the new noun phrase can be searched in a space containing all the node names. For example, the Microsoft Full-Text engine is one such application which can query a search string and return the search result sorted by relevance ranking. Another method involves use of vector representation of the names of the nodes in the BN. The new noun phrases are also converted into a vector and compared to all the existing vectors to find a match. These techniques however fail to map semantically equivalent noun phrases.

For a domain which has a large training data, machine learning techniques such as Weight-normalized Complement Naïve Bayes (WCNB) can be used. The training data consists of a large corpus of semantically mapped noun phrases, which can be used by the WCNB algorithm to calculate the prior probability maximum likelihood estimate for every combination of noun in the domain and noun phrase representing a node. This prior probability is then stored in a mapping table where the columns represent the noun phrases representing the nodes and the rows exhaustively represent the nouns in the domain (as shown in Table 1). Once the training is complete, mapping a noun phrase from text mining to a node in the BN is a simple table lookup to compute the probability of a match. If the probability is above a pre-defined threshold, then a match is deemed to be found.

TABLE 1
STEM CODE MAPPING FOR THE NOUNS

| | Visual problems | Environmental problems |
|---|---|---|
| Eyesight | 0.945 | 0.000 |
| Vision | 0.960 | 0.000 |
| Surrounding | 0.000 | 0.940 |
| Environment | 0.000 | 0.999 |

2. Handling Cycles: The causal association mined could introduce loops in the BN, which should be detected and resolved. Causal loops can exist for two reasons. First, they may be coding mistakes that need to be corrected. Second, they may represent dynamic relations between variables across multiple time frames. While an expert should be required to resolve these loops, an automated system can attempt to look at the chronological order of the nodes in the BN. Since the BNs are built from causal maps, they have an implicit chronological order: the cause has to occur before the effect. Any new association, which draws a relation from a node later on in the existing chronological order to a node earlier, can be flagged as either representing a dynamic relationship or a possible error.

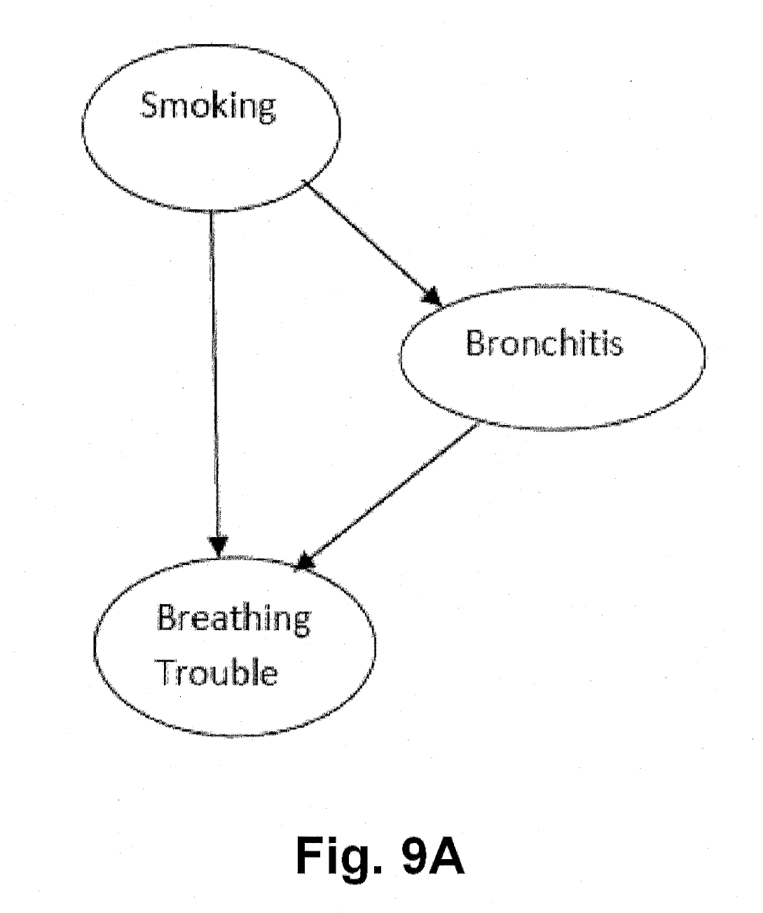

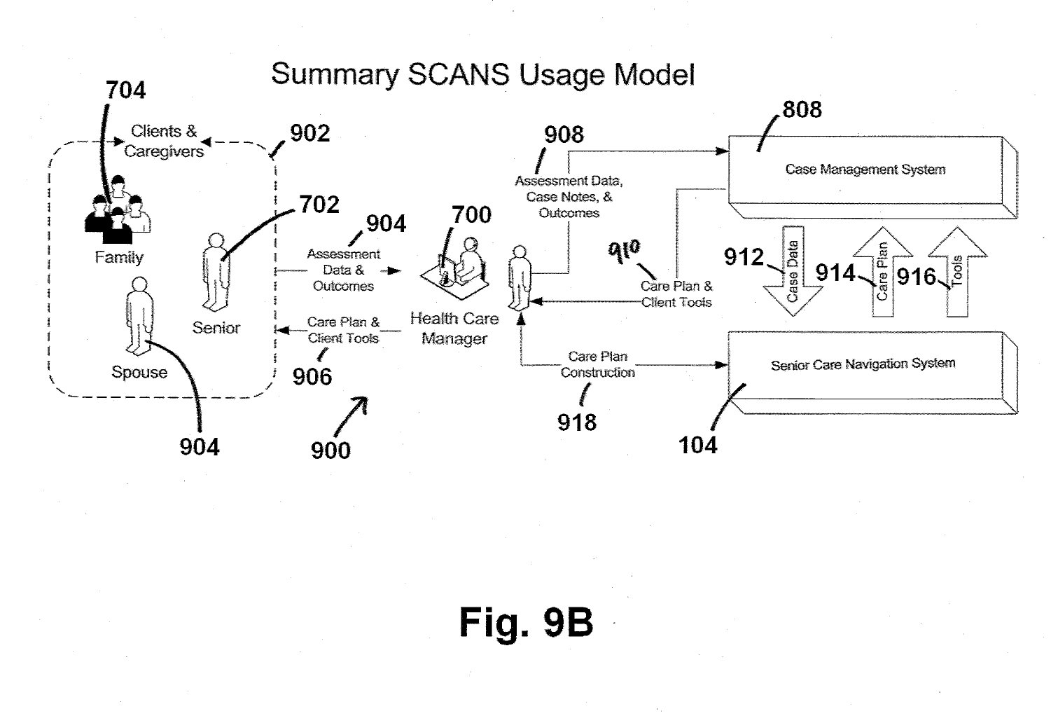

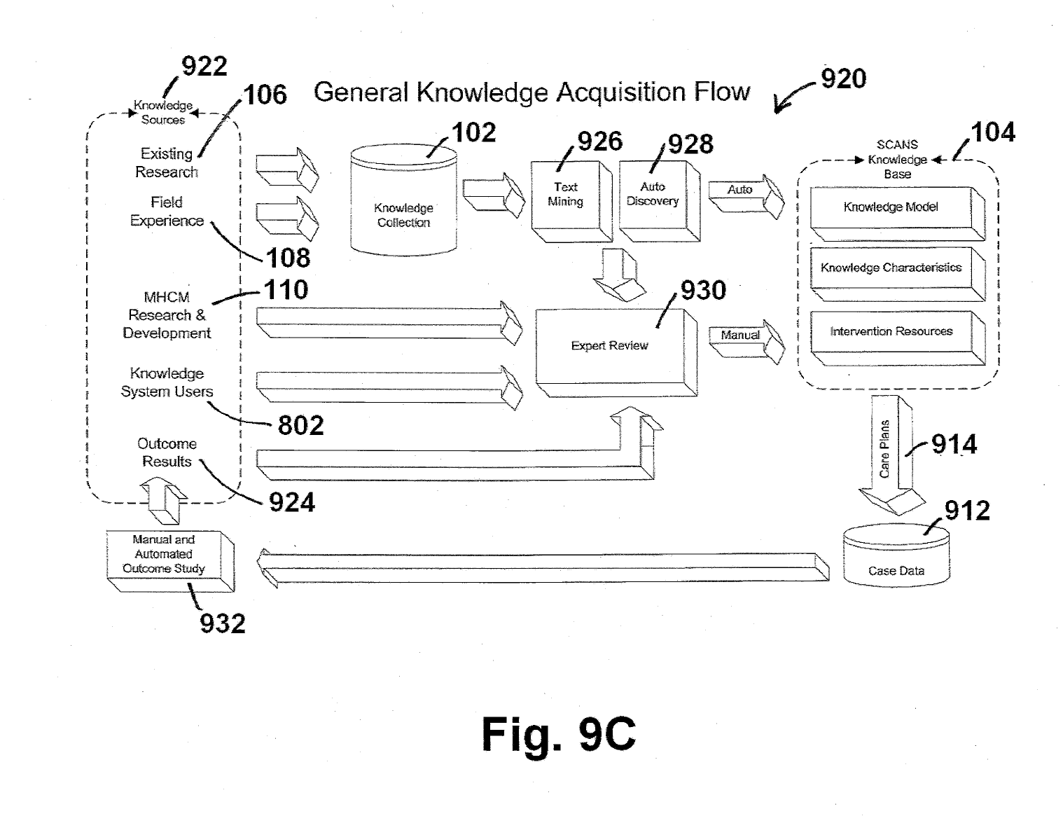

3. Direct and Indirect relations: When faced with multiple paths between nodes (as shown in FIG. 9A, for example), the confidence measure can be used as a parameter to decide which path to retain. For each of the path, the average confidence measure over all the edges in the path can be computed. The path which has the higher confidence measure can be suggested for retaining.

4. Derive the probability: This work proposes the use of confidence measure as a parameter to be stored for every association in a BN. For causal relations mined without a probability value, the number of data evidences discovered to support a particular relation can be stored and the probability updated via truth maintenance. For relations mined with a probability value, the new prior probability is calculated as the weighted average of the old probabilities (OB) and new probabilities (NB) where the weights are the confidence measures (CM) (old confidence (OC) and new confidence (NC):

NP=((OC*OP)+(NC*NP))/(OC+NC) [6]

CM=(OC+NC)/2 [7]

The new probability and confidence measure replace the existing ones for the association in the network. In case of a new relation uncovered from mining, which does not exist in the BN, this method will not be applied since there is no old confidence and prior probability. Instead, the values computed from previous sections will be directly integrated.

An exemplary algorithm of “Generating Bayesian Network based on Text Mining” is shown in Algorithm 1 below. The basic strategy is as follows:
1. Derive causal mapping out of literature using existing text mining techniques.
2. The derived probability is then assessed.
3. Derive the confidence measure based on the influence measure and evidence level of the literature.
4. The casual mapping is then integrated with the Bayesian network, During this process, noun phases are mapped to nodes in a BN, cycles are removed, and direct and indirect relations are handled and the prior probability is derived.
5. After the BN is generated, it is validated and revised validation and according to domain expert feedback.

Algorithm 1:
Generating Bayesian Network with Text Mining

| input: | |
|---|---|
| | Related Literature |
| output: | |
| | A Bayesian Network |
| Begin | |
| 1: | Derive Casual Mappings |
| 2: | Probability assessment |
| 3: | Derive Confidence Measure |
| 4: | Integrate the causal mapping with the BN |

| | |
|---|---|
| 5: | Mapping noun phases to nodes in a BN |
| 6: | Handling Cycles |
| 7: | Handling Direct and Indirect Relations |
| 8: | Derive the prior probability |

| | |
|---|---|
| 9: | BN Validation |

An exemplary system has been tested in texts in geriatrics health care. A software system was developed using SQL scripts in Microsoft SQL Server 2009 Express edition. A snapshot of some of the important tables from the relational database is presented below. Table 2 shows the use of Impact Factor (IF) as the influence measure for journals which is normalized to a value between [0, 1]. Table 3 shows the exemplary publications used for text mining, Table 4 shows the causal associations mined from text, their evidence levels, probabilities and also the confidence measure derived as described above. The shading levels indicate the causal associations which refer to the same relationship and need to be aggregated via weighted mean as previously described. Table 5 shows the result of this aggregation which then needs to be converted into a conditional probability table by the expert. The system can also map the noun phrases to the nodes in the existing BN. ‘Source’ and ‘Target’ nodes represent the ‘cause’ and ‘effect’ respectively. A ‘null’ value indicates that the corresponding keyword is newly discovered and may require structural changes to the BN in the form of new nodes and edges to other nodes.

TABLE 2
PUBLICATIONS AND THEIR IMPACT FACTOR.

| Publication ID | Name | Raw IF | Normalized IF |
|---|---|---|---|
| 18 | Journal 1 | 3.53900 | 0.72176 |
| 69 | Journal 2 | 2.92500 | 0.66131 |
| 70 | Journal 3 | 1.91000 | 0.56137 |
| 71 | Journal 4 | 6.36500 | 1.00000 |
| 72 | Journal 5 | 5.85400 | 0.94969 |

TABLE 3
PUBLICATIONS USED FOR THE TEXT MINING.

| Src ID | Publication ID | Date | Title | Author |
|---|---|---|---|---|
| 15 | 18 | 2001 | Title 1 | J Doe |
| 20 | 69 | 2000 | Title 2 | P Stevens |
| 21 | 70 | 2001 | Title 3 | S Graf |
| 22 | 71 | 2005 | Title 4 | B Borg |
| 23 | 72 | 2003 | Title 5 | I Lendl |

TABLE 4
EVIDENCE TABLE WITH CAUSAL ASSOCIATIONS.

| Evid | Src | | | Evid | | |
|---|---|---|---|---|---|---|
| ID | ID | Cause | Effect | Level | Prob | Conf |
| 37 | 15 | steps | fall risk | 0.9500 | 0.7000 | 0.8359 |
| 38 | 15 | rugs and | fall risk | 1.0000 | 0.6500 | 0.8609 |
| | | mats | | | | |
| 39 | 20 | trailing | fall risk | 0.9000 | 0.3300 | 0.7807 |
| | | cord | | | | |
| 40 | 22 | hazardous | fall risk | 0.8500 | 0.3900 | 0.9250 |
| | | floor | | | | |
| 41 | 21 | lighting | fall risk | 1.0000 | 0.2300 | 0.7807 |
| | | deficient | | | | |
| 42 | 20 | obstacles | fall risk | 0.9500 | 0.4300 | 0.8057 |
| 43 | 23 | stepovers | fall risk | 0.9500 | 0.3200 | 0.9499 |
| 44 | 21 | wet | fall risk | 0.8000 | 1.0000 | 0.6807 |
| | | bathroom | | | | |
| | | floor | | | | |
| 45 | 20 | steps | fall risk | 0.9500 | 0.8000 | 0.8057 |
| 46 | 21 | rugs and | fall risk | 1.0000 | 0.7500 | 0.7807 |
| | | mats | | | | |
| 47 | 20 | trailing | fall risk | 0.9000 | 0.4500 | 0.7807 |
| | | cord | | | | |
| 48 | 21 | hazardous | fall risk | 0.9500 | 0.2500 | 0.7557 |
| | | floor | | | | |

TABLE 5
AGGREGATED RESULT TO BE CONVERTED TO A BN.

| Evid ID | Source Node | Target Node | Probability | Confidence |
|---|---|---|---|---|
| 45 | 9 | 1 | 0.74908 | 0.82080 |
| 46 | 4 | 1 | 0.69756 | 0.82080 |
| 47 | 3 | 1 | 0.39000 | 0.78070 |
| 48 | 6 | 1 | 0.36041 | 0.82880 |
| 41 | 2 | 1 | 0.23000 | 0.78070 |
| 43 | NULL | 1 | 0.32000 | 0.94990 |
| 44 | NULL | 1 | 1.00000 | 0.06807 |

An exemplary summary SCANS 104 usage model of the present disclosure is shown in FIG. 9B. As shown in FIG. 9B, usage model 900 allows information to pass back and forth from GCM 700 (shown as “Health Care Manager” in the figure) to various clients & caregivers 902, including the senior 702, the senior's family 704, and/or the senior's spouse 904. Such information may include assessment data & outcomes 904 provided from various clients & caregivers 902 to GCM 700, and care plan & client tools 906 provided from GCM 700 to various clients & caregivers 902.

GCMs 700 work with seniors 702 and their caregivers to assess and understand the current situation in, for example, the seventeen (17) dimensions referenced earlier. As shown in FIG. 9B, assessment data, case notes & outcomes 908 of the GCMs 700 may be entered into case management system 808. Case management system 808 may provide a number of care plans & client tools 910 to GCM 700 based on such information (e.g., medication list, ready reference wallet card, etc.). Case data 912 from case management system 808 may then be passed to SCANS 104 for analysis, and may provide various care plans 914 and tools 916 back to case management system 808 as generally referenced within the present disclosure. In addition, SCANS 104 may provides a care planning construction 918 interface to adjust and append to the care plan 914 and then return that care plan 914 along with various tools 916 to case management system 808 for tracking. These care plans 914 and tools 916 are shared with the clients & caregivers 902 (shown as care plan & client tools 906 in the figure) for implementation and outcomes (from assessment data & outcomes 904) are tracked over time. Reassessments may be periodically performed, thus repeating the cycle.

An exemplary general knowledge acquisition flow of the present disclosure is shown in FIG. 9C. As shown in FIG. 9C, flow 920 shows the general acquisition of information by SCANS 104 from various information sources, and how such information is used by SCANS 104. In the exemplary embodiment shown in FIG. 9C, information from various knowledge sources 922, including, but not limited to, existing research (standards of care 106), field experience (clinical expertise 108), internal research and development (member records 110), knowledge system users 802, and various outcome results 924, may be examined and mined using both automated and manual approaches. Existing research (standards of care 106) and field experience (clinical expertise 108), making up at least part of a general knowledge collection (evidence repository 102) may be collected and screened using automated techniques such as text mining 926 and auto discovery 928. Internal research and development (member records 110) and information from knowledge system users 802 may be already aligned to the SCANS 104 knowledge base and require only manual vetting (by way of, for example, expert review 930), linkage, and implementation. Some knowledge discoveries can be automatically inserted into the knowledge base (SCANS 104), particularly as they relate to knowledge characteristics such as confidence, weight, or probabilities. Other items, such as the discovery of new associations between findings and interventions, may require expert review 930, but sifting large collections of data and highlighting these discoveries dramatically accelerates knowledge base (SCANS 104) updates and improves currency with emerging best practice. Furthermore, case data 912 may be collected over time including outcomes information on both acceptability and results of interventions, which may comprise at least part of for example, various care plans 914. This information is analyzed using for study techniques as well as automated statistical screening to discovery new knowledge and information on efficacy, and may then be reviewed and updated in SCANS 104. Case data 912, as shown in FIG. 9C, may lead to the preparation of manual and automated outcome study information 932, which may be fed back tout least one of the various knowledge sources 922.

The various SCANS 104 knowledge acquisition processes of the present disclosure operate above and beyond processes known in the art, using, for example, the following unique innovations:
1. Text mining, as referenced herein, may capture probabilistic or belief measures that are related to the “noun-phrase verb noun-phrase” associations, extending the associations to handle disjunctions or conjunctions of subject and/or predicate. New terms of interest can then be identified via linguistic analysis of sentences with known ties to an ontology.
2. Text mining may also capture adjectives and/or adverbs which qualify a noun or verb to describe the degree to which a cause, effect, or association is present or is increased or decreased in severity or frequency of occurrence. This allows nature nodes in a Bayesian network (as referenced herein) to have multiple states, instead of simply being boolean.
3. Association discovery may operate to aggregate evidence about an association from multiple sources to provide an overall weight for the evidence and probability distribution for the association.
4. Knowledge assimilation may analyze the probabilistically-qualified associations, applying ontological terms, to arrive at domain-specific relations, such as:
   a. Single cause to single effect with probability of occurrence of the effect based on the cause;
   b. Probability of an event (cause) within a population;
   c. Multiple causes, any one of which may produce the effect;
   d. Multiple causes, most/all of which are required to produce the effect;
   e. Effectiveness of a given solution on the severity or occurrence (or prevention) of a given problem;
   f. Effectiveness of a given solution on the severity or occurrence (or prevention) of a given problem, given the presence/absence of other influencing factors;
   g. Effectiveness of a given set of solutions on the severity or occurrence (or prevention) of a given problem; and/or
   h. Effectiveness of a given solution on the severity or occurrence (or prevention) of a given problem, given the presence/absence of other influencing factors.
5. Bayesian knowledge models may be extended or updated to assimilate the newly-discovered associations, whereby:
   a. Noun-phrases may be mapped to Bayesian nature or decision nodes of a Bayesian network using existing matching/ranking techniques;
   b. New associations between two previously unrelated Bayesian nodes may be formed, using the prior and/or conditional probabilities mined from the text;
   c. New nodes may be added, and associations formed between new and/or existing nodes, using the prior and/or conditional probabilities mined from the text; and/or
   d. Existing nodes and influence relationships may be updated based on the mined probabilities, and averaged with existing probabilities based on the strength of the evidence associated with the new nodes and/or relationships.

### Example 1

### My Health Care Manager

As referenced herein, SCANS 104 is operable to generate one or more care plans for use by a GCM 700 with a senior 702 and his or her family 704. Such plans may be formulated as a result applying the aforementioned reasoning techniques on the knowledge base, by keyword searching, and/or by examination of the health care hierarchy. The GCM 700 (or knowledge system user 802) may then interact with the various systems of the present disclosure to adjust the plans.

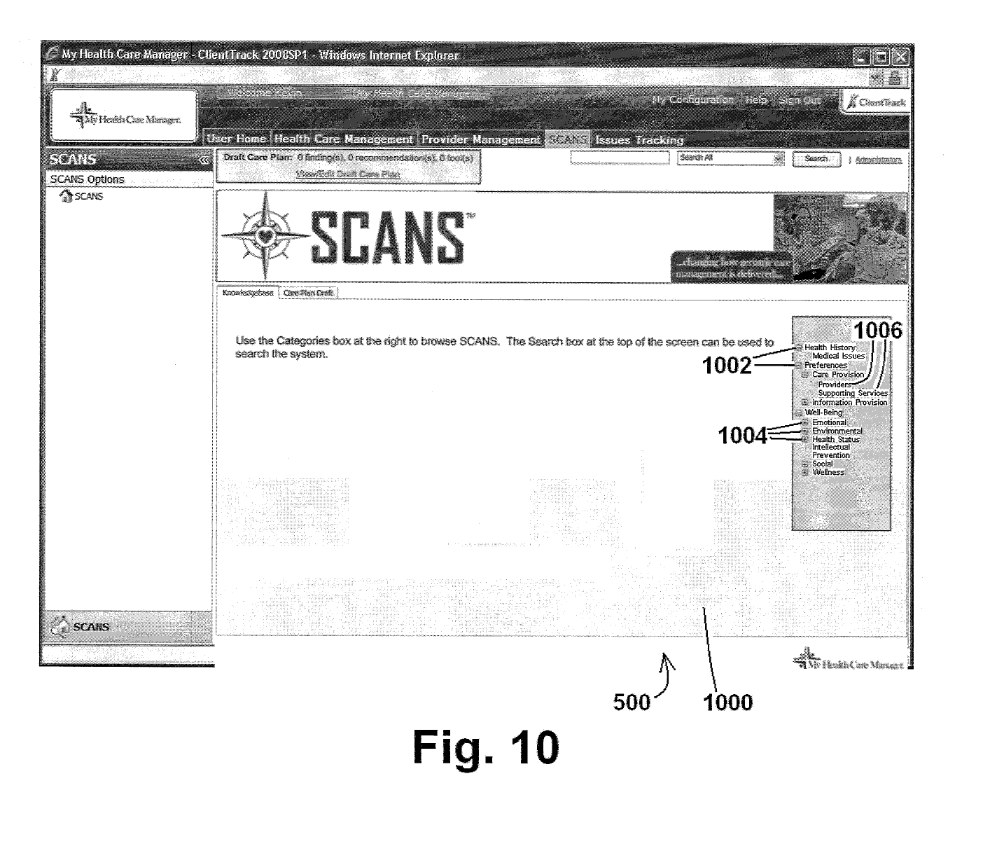

An exemplary category selection screen 1000 of a system for preparing a care plan 500 of the disclosure of the present application is shown in FIG. 10. As shown in FIG. 10, category selection screen comprises at least one main category 1002, each main category 1002 comprising at least one secondary category 1004. Secondary categories 1004 may be visually represented hierarchically from main categories 1002 as shown in FIG. 10. In the exemplary embodiment shown in FIG. 10, exemplary main categories 1002 include “Health History,” “Preferences,” and “Well-Being,” and exemplary secondary categories 1004 include “Medical Issues,” “Care Provision,” “Emotional,” “Environmental,” “Health Status,” “Social,” and “Wellness.”

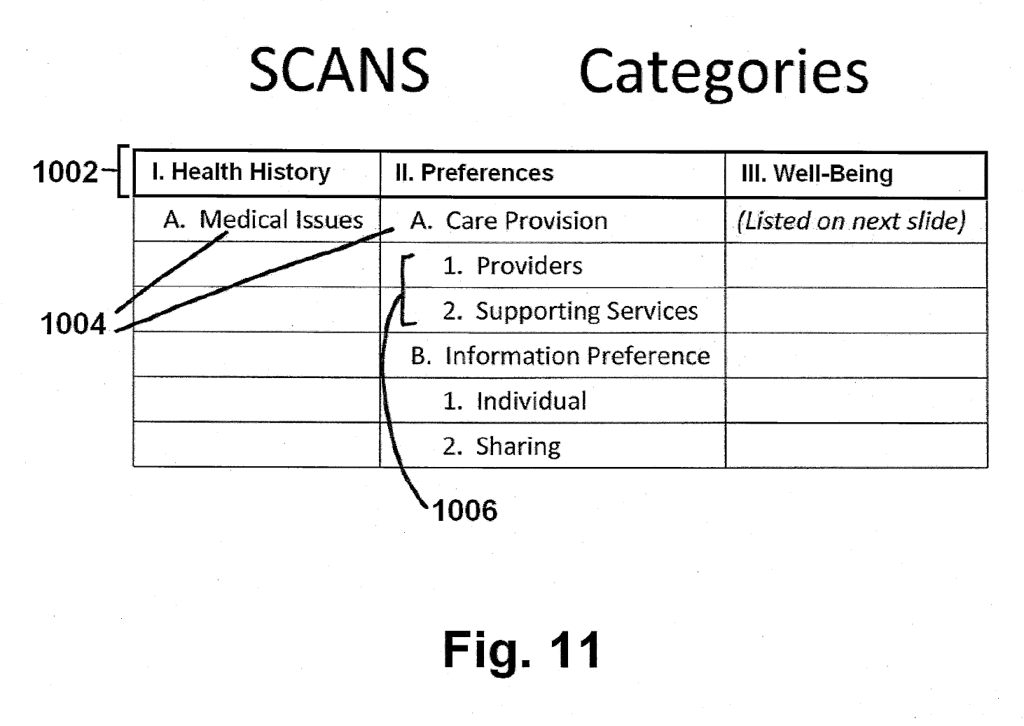

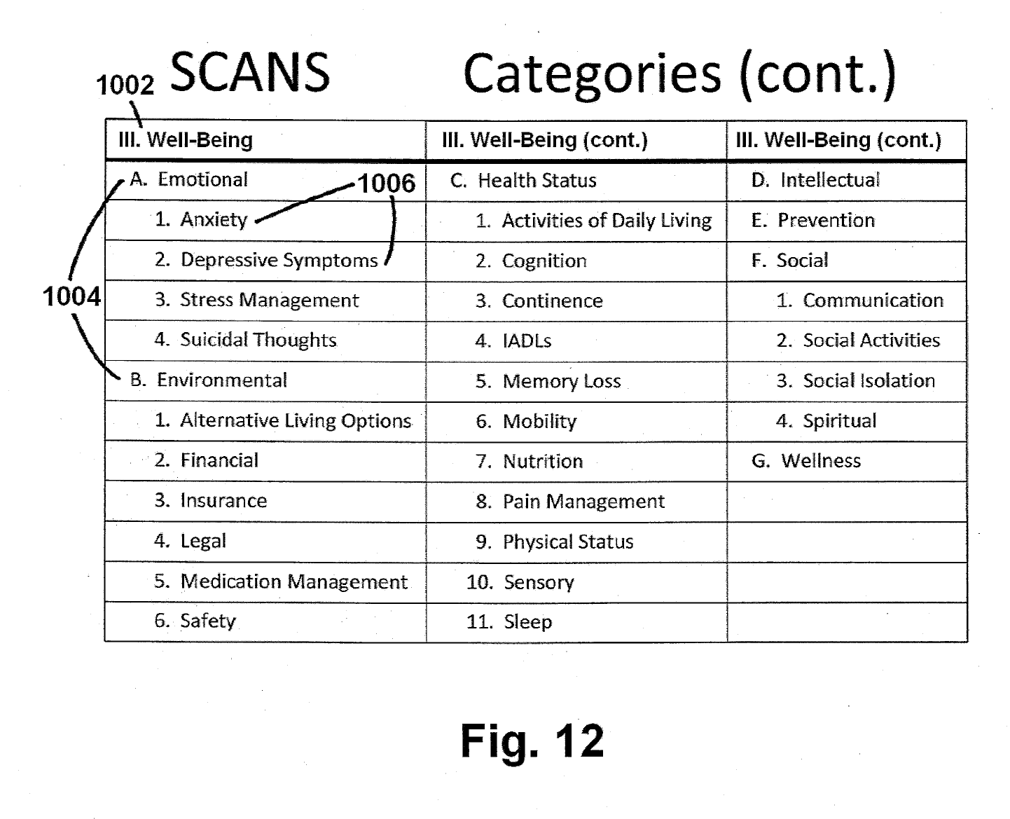

In at least one embodiment, a secondary category 1004 may comprise a tertiary category 1006, and so forth. As shown in FIG. 10, exemplary tertiary categories 1006 include “Providers” and “Supporting Services” under the secondary category 1004 “Care Provision.” In various embodiments of category selection screens 1000 of the present disclosure, category selection screens 1000 may comprise any number of main categories 1002, secondary categories 1004, and tertiary categories 1006, each covering various topics applicable to a system for preparing a care plan 500. Additional exemplary main categories 1002 (represented by Roman numerals), secondary categories 1004 (represented by letters), and tertiary categories 1006 (represented by Arabic numerals) are shown in FIGS. 11 and 12.

As previously referenced herein, this information has been further categorized into 25 domains referred to as Care Categories. These categories and the category structure have and may continue to evolve as part of the dynamic structure of the ontology for geriatric care. In addition to the identification of the goals, issues, and risks themselves, information on solutions is kept. The solution information, in at least one embodiment, may be grouped under the following headings: Education and Awareness, Prevention, Intervention, Protocols, and Tools. Such a repository, illustrated here, will serve as the base information to load into the more advanced knowledge base implementation of SCANS 104, enabling HCMs to increase the speed and quality of the content collection, assimilation, and deployment.

Upon selection of a main category 1002, secondary category 1004, or tertiary category 1006, a user of a system for preparing a care plan 500 is directed to one or more draft care plan screen 1100, an exemplary draft care plan screen 1100 shown in FIG. 13. A user of system 500 may be identified in user field 1008 as shown in FIGS. 10 and 13 and in other figures included with the present disclosure.

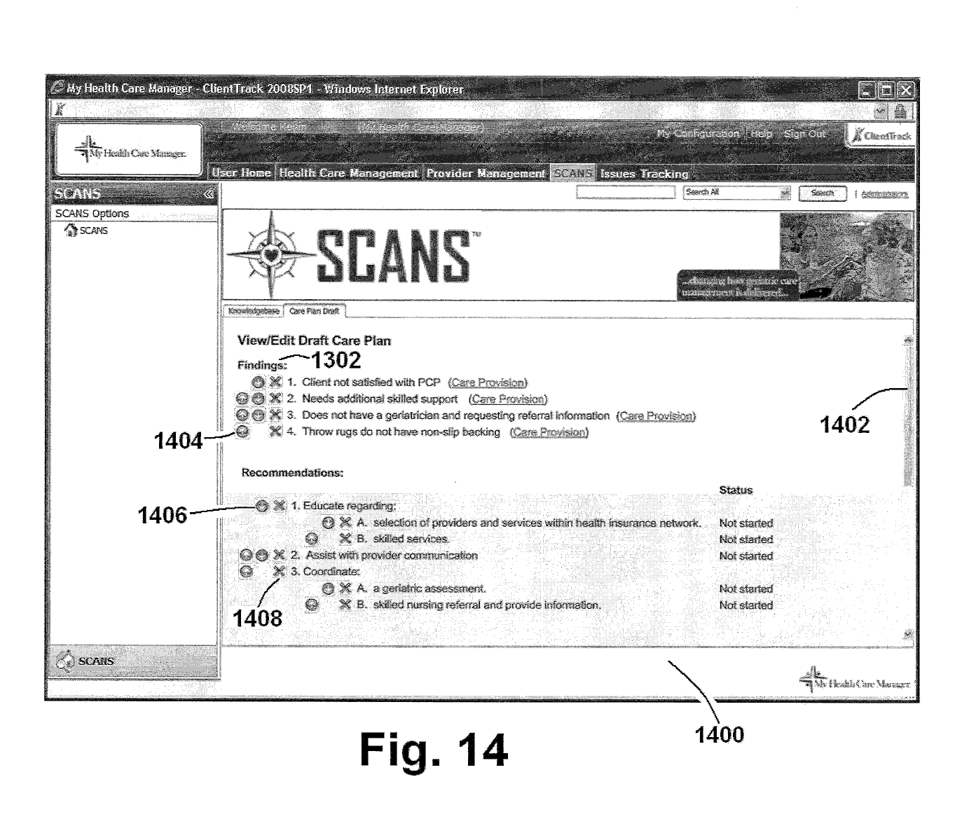

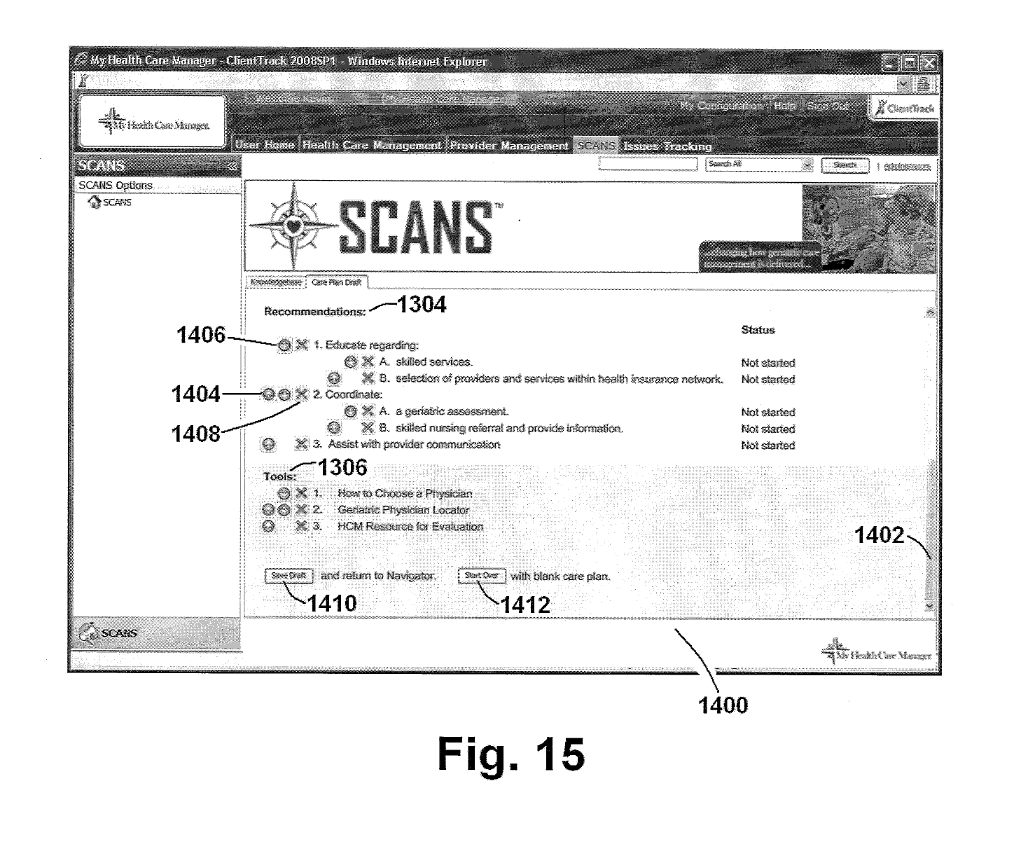

As shown in the exemplary embodiment of a draft care plan screen 1100 shown in FIG. 13, draft care plan screen 1300 identifies various findings 1302, recommendations 1304, and tools 1306 relating to the selected main category 1002, secondary category 1004, or tertiary category 1006. In the embodiment of a draft care plan screen 1100 shown in FIG. 13, a user has selected secondary category 1004 “Care Providers,” which reveals a series of findings 1302, recommendations 1304, and tools 1306 applicable to that selected secondary category 1004. A user of system 500 may then select one or more findings 1302, recommendations 1304, and/or tools 1306 applicable to a client, with submission of those selected findings 1302, recommendations 1304, and/or tools 1306 at draft care plan screen 1100 leading to one or more view/edit draft care plan screens 1400 as shown in FIGS. 14 and 15. As shown in FIG. 14, exemplary view/edit draft care plan screen 1400 comprises findings 1302 and recommendations 1304 selected by a user from draft care plan screen 1100, and as shown in FIG. 15, exemplary view/edit draft care plan screen 1400 comprises recommendations 1304 and tools 1306 selected by a user from draft care plan screen 1100. As shown by optional scroll bar 1402 on the right side of view/edit draft care plan screen 1400, various portions of a view/edit draft care plan screen 1400 may be shown at once. For example, an upper portion of view/edit draft care plan screen 1400 is shown in FIG. 14, and a lower portion of view/edit draft care plan screen 1400 is shown in FIG. 15, indicated by the selected level of scroll bar 1402.

As shown in the exemplary embodiments of view/edit draft care plan screens 1400 shown in FIGS. 14 and 15, view/edit draft care plan screens 1400 comprise one or more level up buttons 1404, level down buttons 1406, and remove buttons 1408, positioned next to the various findings 1302, recommendations 1304, and/or tools 1306 shown on the view/edit draft care plan screen 1400. Selection of a level up button 1404 would raise the selected finding 1302, recommendation 1304, or tool 1306 if the finding 1302, recommendation 1304, or tool 1306 is not already at the top, and selection of a level down button 1406 would lower the selected finding 1302, recommendation 1304, or tool 1306 if the finding 1302, recommendation 1304, or tool 1306 is not already at the bottom. In addition, selection of a remove button 1408 would remove the selected finding 1302, recommendation 1304, or tool 1306 from the screen. The one or more level up buttons 1404, level down buttons 1406, and remove buttons 1408 allow a user of system 500 to tailor a client's care plan with content and in the order desired by the user.

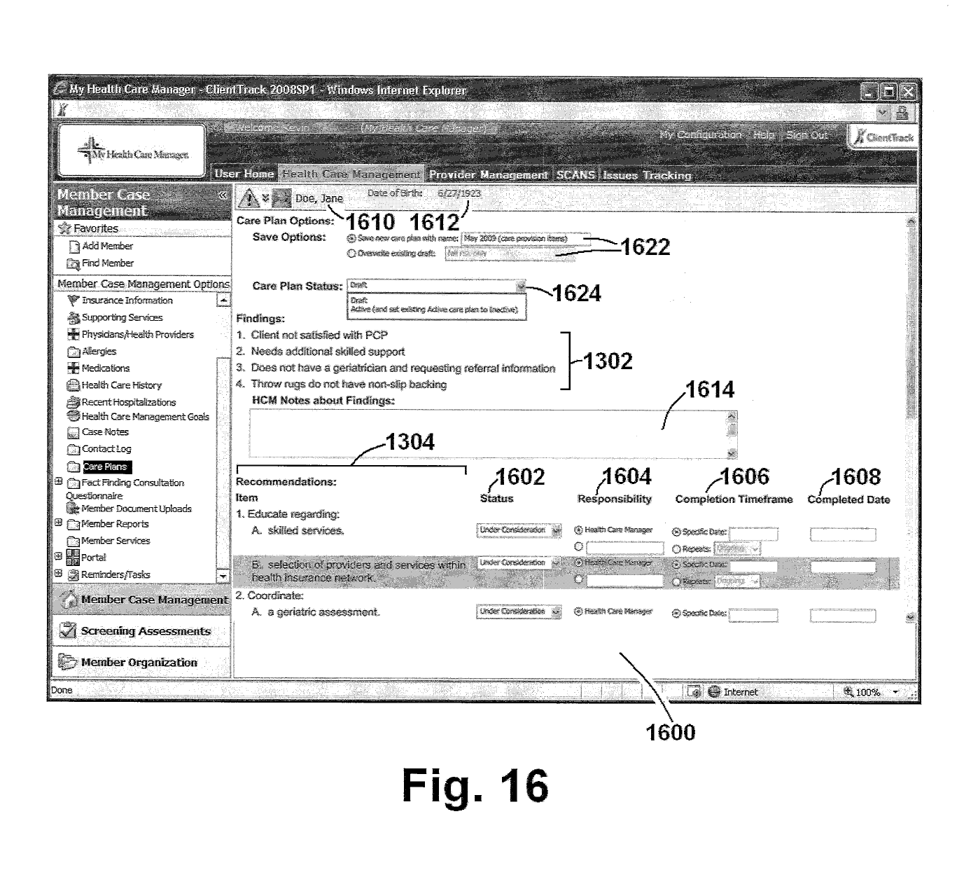

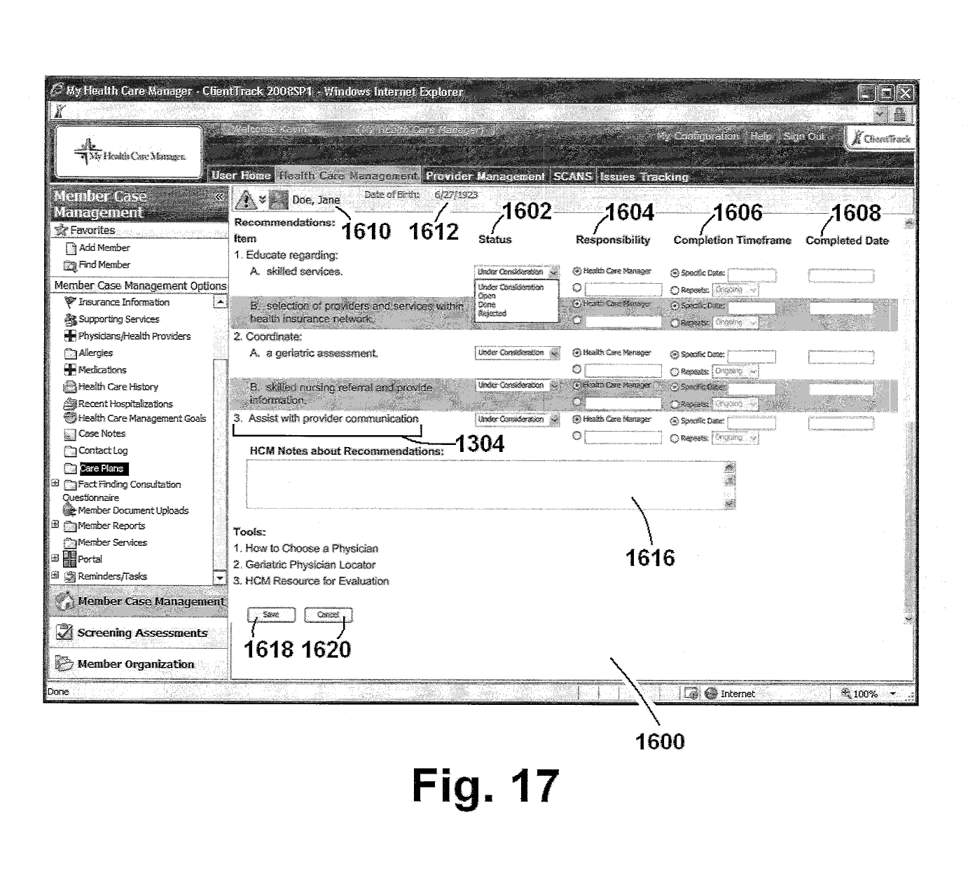

Upon completion of a client's draft care plan, a user of system 500 may proceed with the selection and/or identification of various care plan options as shown in a care plan options screen 1600, an example of which is shown in FIGS. 16 and 17. A user may proceed from view/edit draft care plan screen 1400 by, for example, selecting save draft button 1410 as shown in FIG. 14, or a user may decide to start over and return to draft care plan screen 1100 upon selection of start over button 1412.

An exemplary care plan options screen 1600, as shown in FIGS. 16 and 17, provides a user of system 500 with an options list in connection with the various findings 1302 and recommendations 1304 for a particular client. For example, the findings 1302 and recommendations 1304 selected by a user of system 500 as shown in FIG. 13 appear within FIGS. 16 and 17, with the findings 1302 provided near the top of the exemplary care plan options screen 1600 shown in FIG. 16 in the order as selected by the user as shown in FIG. 14, forming an individual care plan for a particular client. Recommendations 1304 are shown in FIGS. 16 and 17 also in the order as selected by a user in FIG. 14, providing the user with options to provide status information 1602, responsibility information 1604, completion timeframe information 1606, and completed date information 1608 as shown in FIGS. 16 and 17. For example, and as shown in the drop down menu for status information 1604 shown in FIG. 17, a user may select “Under Consideration,” “Open,” “Done,” or “Rejected” to identify the status of a particular recommendation 1304. A user may also identify an individual or entity in the responsibility information 1604 section, noting that “Health Care Manager” may be a default selection that can be overridden by entering an individual or entity in the box provided under responsibility information 1604. The completion time frame information 1606 section allows a user to insert timeframe data, including a specific date and optional repeat data if the particular recommendation 1304 is to be addressed over a series of days, weeks, or months. When a particular recommendation 1304 has been completely acted upon or otherwise finalized, a user of system 500 may enter a date in the completed date information 1608 section in connection with that particular recommendation 1304. In addition to the foregoing, the selected tools 1306 from FIG. 13 are shown in FIG. 17 in the order as selected by the user in FIG. 14.

An exemplary care plan options screen 1600 may comprise a number of additional features/elements as shown in FIGS. 16 and 17. For example, the left-side toolbar with the heading “Member Case Management” may include a “Favorites” list to provide a user with efficient access to frequently used portions of system 500, and may include a number of “Member Case Management Options” in connection with a particular client, which may also be identified in client name section 1610 and client birth date section 1612 near the top of the figures. The aforementioned toolbar may include additional items such as “Member Case Management,” “Screening Assessments,” and “Member Organization” as shown in FIGS. 16 and 17, and may provide various saving options (including the option to save a new care plan or overwrite an existing draft) and care plan status details (including “Draft” and “Active”) as shown in the Figures. Furthermore, an exemplary care plan options screen 1600 may also comprise a findings note field 1614 and a recommendations note field 1616 whereby a user (identified as “HCM” for “Health Care Manager” in connection with those two field) may enter text for reference in connection with various findings 1302 and recommendations 1304.

Upon completion of an exemplary care plan options screen 1600 as shown in FIG. 17, a user may select save button 1618 to proceed to the next logical screen within system 500. Alternatively, a user may select cancel button 1620 to cease entering information within system 500. The selection of save button 1618 would save the information entered in the screen by the user, to be identified by individual care plan title 1622 and individual care plan status 1624 entered or selected by the user as shown in FIG. 16.

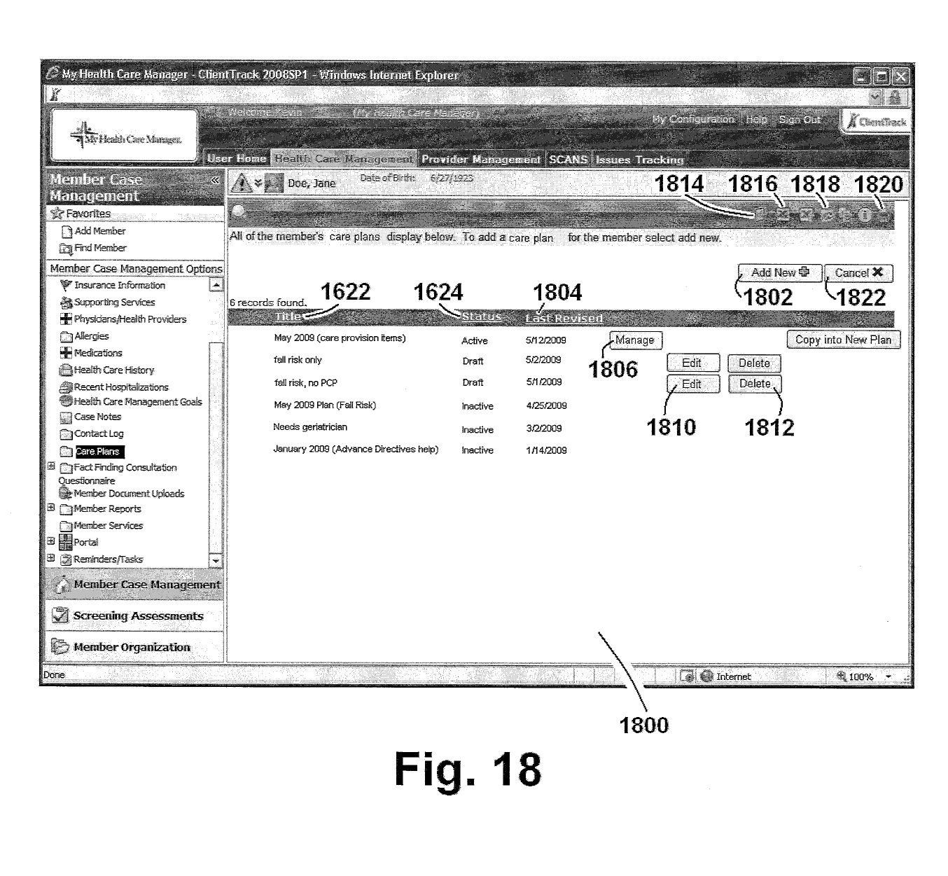

An exemplary care plan summary screen 1800 of the disclosure of the present application is shown in FIG. 18. As shown in FIG. 18, care plan summary screen 1800 identifies various individual care plans in connection with a client, including, for example, the care plan entitled “May 2009 (care provision items)” as identified in FIGS. 16 and 17. Care plan summary screen 1800 may, as shown in FIG. 18, provide a user of system 500 with the opportunity to add a new individual care plan upon selection of add new button 1802 or view various details of other individual care plans. In the example shown in FIG. 18, the client has six individual care plans identified by their individual care plan titles 1622, individual care plan status 1624, and last revised date 1804. Depending on individual care plan status 1624, a user may perform various tasks associated with specific care plans, including managing a care plan (upon selection of manage button 1806), copying a care plan into a new care plan (upon selection of manage button 1808) for active care plans, and editing (upon selection of edit button 1810) and deleting (upon selection of delete button 1812) care plans in draft status as shown in FIG. 18.

A user of system 500 has various additional options with in connection with an individual care plan or care plan summary. For example, a user may select (i) word processor button 1814 to view the care plan in a word processor, (ii) spreadsheet button 1816 to view the care plan in spreadsheet form, (iii) discard button 1818 to discard a care plan, and/or (iv) print button 1820 to print a care plan or care plan summary. If a user desires no changes to a care plan or desires no further actions with respect to a care plan from care plan summary screen 1800, the user may select cancel button 1822 to exit care plan summary screen 1800.

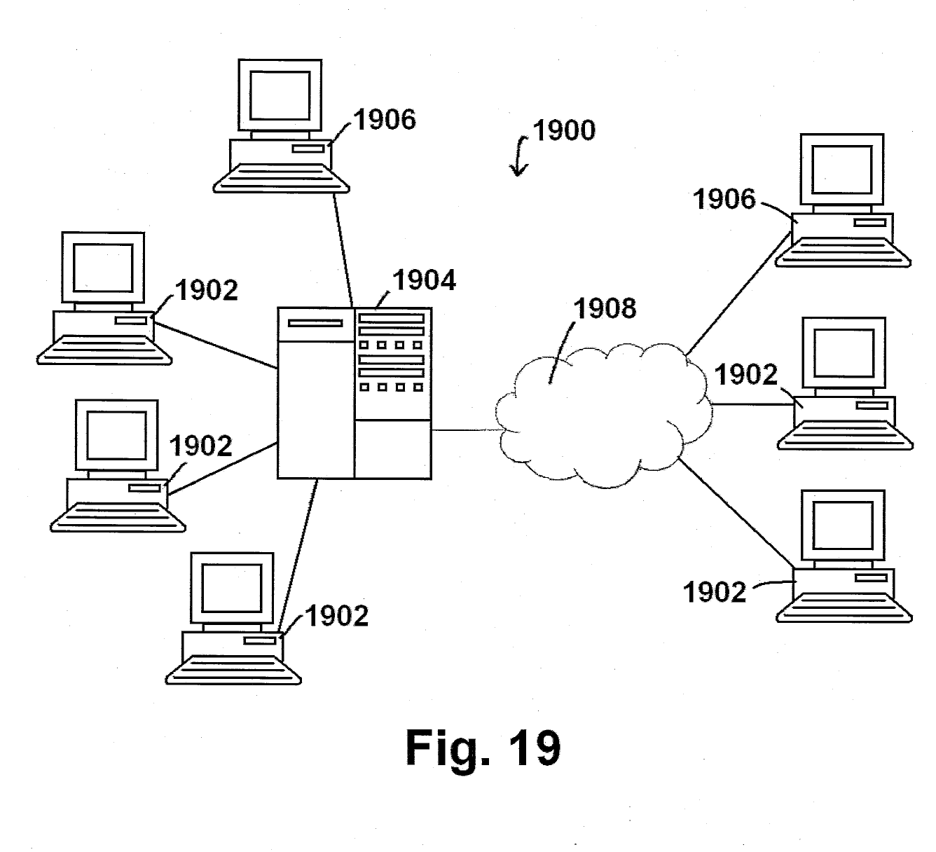

The various systems of the present disclosure may operate on a computer network with one or more of the features shown in FIG. 19. As shown in exemplary system framework 1900 shown in FIG. 19, one or more user computers 1902 may be operably connected to a system server 1904. A user computer 1902 may be a computer, computing device, or system of a type known in the art, such as a personal computer, mainframe computer, workstation, notebook computer, laptop computer, hand-held computer, wireless mobile telephone, personal digital assistant device, and the like.

One or more administrator computers 1906 may also be operably connected to system server 1904 including through a network 1908 such as the Internet. Administrator computers 1906, similar to user computers, may be computers, computing devices, or systems of a type known in the art, such as a personal computers, mainframe computers, workstations, notebook computers, laptop computers, hand-held computers, wireless mobile telephones, personal digital assistant devices, and the like. In addition, user computers and administrator computers may each comprise such software (operational and application), hardware, and componentry as would occur to one of skill of the art, such as, for example, one or more microprocessors, memory, input/output devices, device controllers, and the like. User computers and administrator computers may also comprise one or more data entry means (not shown in FIG. 19) operable by a user of client computer and/or an administrator computer, such as, for example, a keyboard, keypad, pointing device, mouse, touchpad, touchscreen, microphone, and/or other data entry means known in the art. User computers and administrator computers also may comprise an audio display means (not shown in FIG. 19) such as one or more loudspeakers and/or other means known in the art for emitting an audibly perceptible output. The configuration of User computers and administrator computers in a particular implementation of one or more systems of the present disclosure is left to the discretion of the practitioner.

System server 1904 may comprise one or more server computers, computing devices, or systems of a type known in the art. System server 1904 may comprise server memory. System server 1904 may comprise one or more components of solid-state electronic memory, such as random access memory. System server 1904 may also comprise an electromagnetic memory such as one or more hard disk drives and/or one or more floppy disk drives or magnetic tape drives, and may comprise an optical memory such as a Compact Disk Read Only Memory (CD-ROM) drive, System server 1904 may further comprise such software (operational and application), hardware, and componentry as would occur to one of skill of the art, such as, for example, microprocessors, input/output devices, device controllers, video display means, and the like.

System server 1904 may comprise one or more host servers, computing devices, or computing systems configured and programmed to carry out the functions allocated to system server 1904. System server 1904 may be operated by, or under the control of, a “system operator,” which may be an individual or a business entity. For purposes of clarity, System server 1904 is shown in FIG. 19 and referred to herein as a single server. System server 1904 need not, however, be a single server. System server 1904 may comprise a plurality of servers or other computing devices or systems connected by hardware and software that collectively are operable to perform the functions allocated to the various systems of present disclosure. Specifically, system server 1904 may be operable to be a web server, configured and programmed to carry out the functions allocated to a system server according to the present disclosure. Further, although user computers 1902 and administrator computers 1906 may be connected directly to system server 1904, these computers may be connected to system server 1904 through any suitable network such as network 1908. Further, in one embodiment, the users need not be provided access to system server 1904 but instead the content posts from users are made by the user(s) and saved to one or more particular locations and the posts are accessed or harvested by the administrator or system automatically.

System server 1904 may be operably connected to the various user computers 1902 and/or an administrator computers 1906 by network 1908, which in an embodiment of the present disclosure comprises the Internet, a global computer network. However, network 1908 need not comprise the Internet. Network 1908 may comprise any means for electronically interconnecting system server 1904 and a user computer 1902 and/or an administrator computer 1906. Thus, it will be appreciated by those of ordinary skill in the art that the network 1908 may comprise the Internet, the commercial telephone network, one or more local area networks, one or more wide area networks, one or more wireless communications networks, coaxial cable, fiber optic cable, twisted-pair cable, the equivalents of any of the foregoing, or the combination of any two or more of the foregoing. In an embodiment where system server 1904 and user computer 1902 and/or an administrator computer 1906 comprise a single computing device operable to perform the functions delegated to both system server 1904 and user computer 1902 and/or an administrator computer 1906 according to the present disclosure, network 1908 comprises the hardware and software means interconnecting system server 1904 and user computer 1902 and/or an administrator computer 1906 within the single computing device. Network 1908 may comprise packet switched facilities, such as the Internet, circuit switched facilities, such as the public switched telephone network, radio based facilities, such as a wireless network, etc.

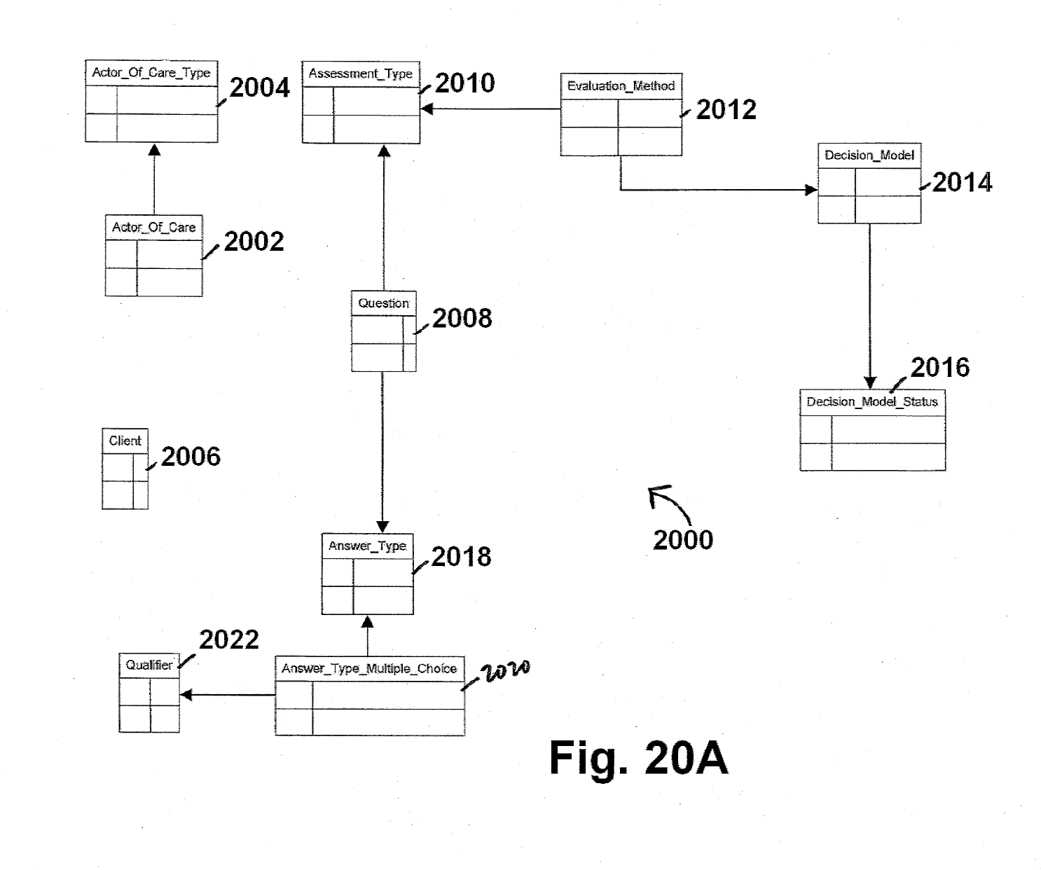

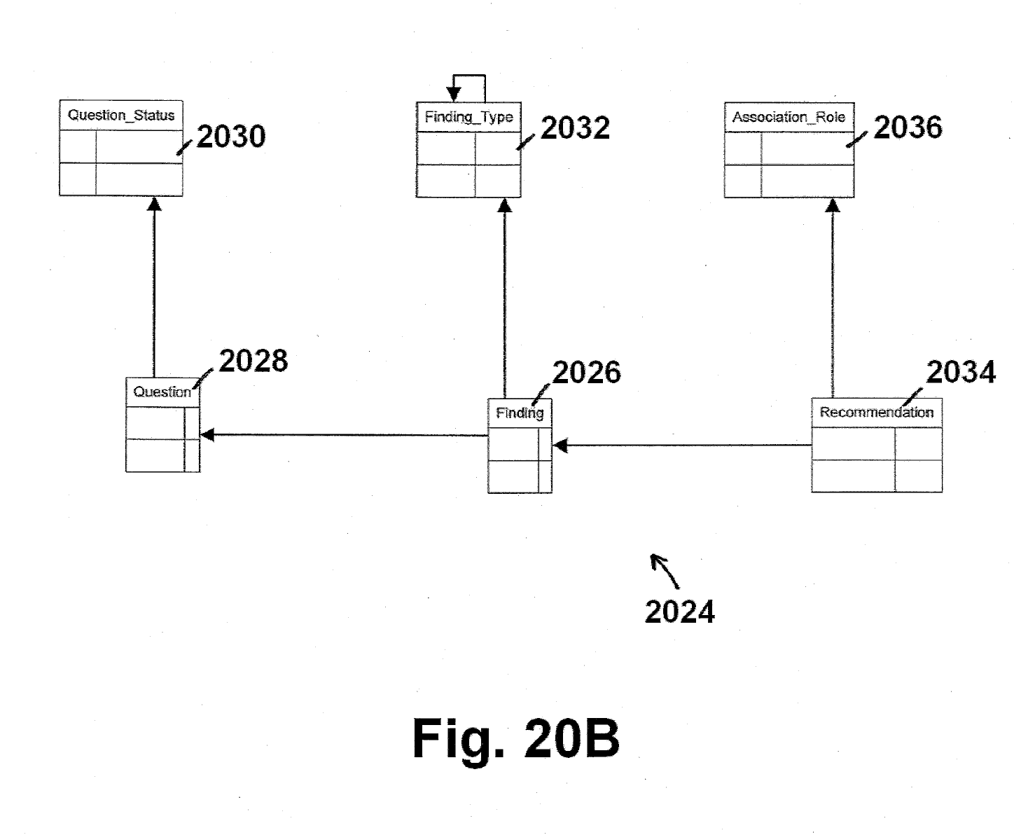

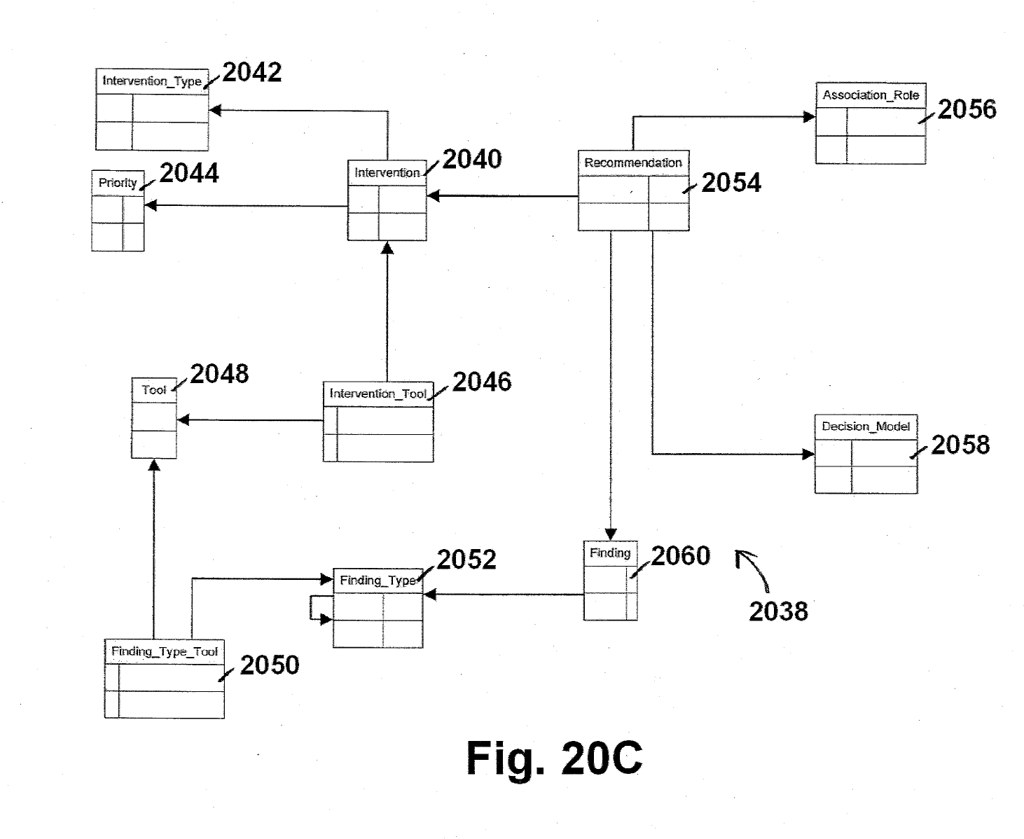

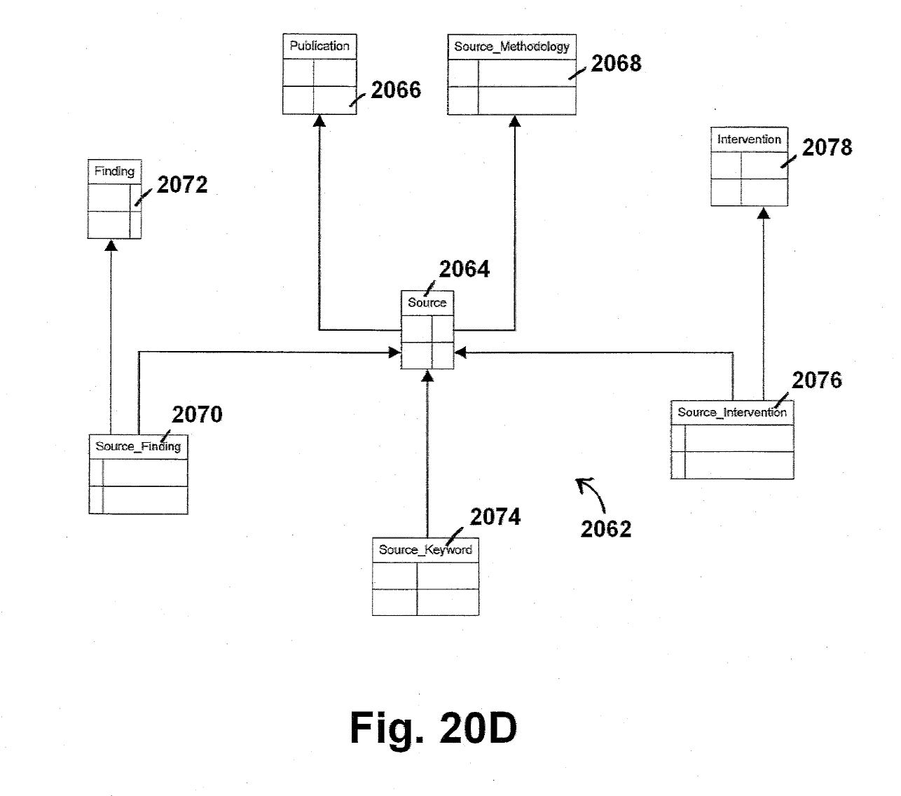

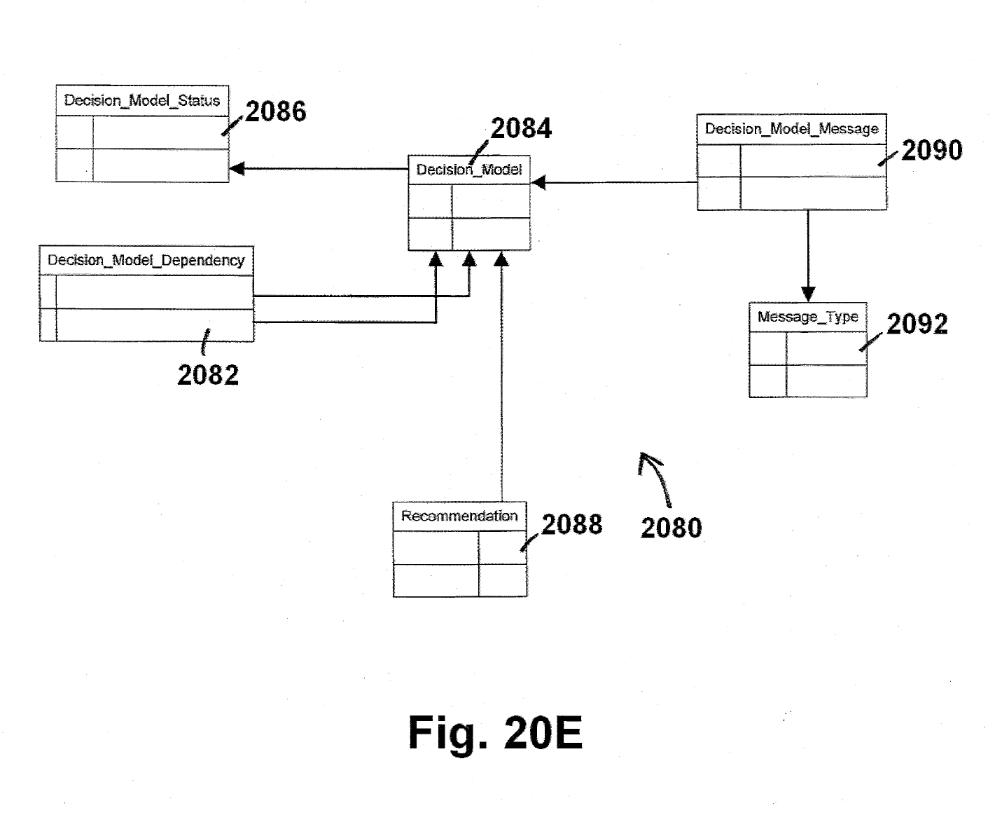

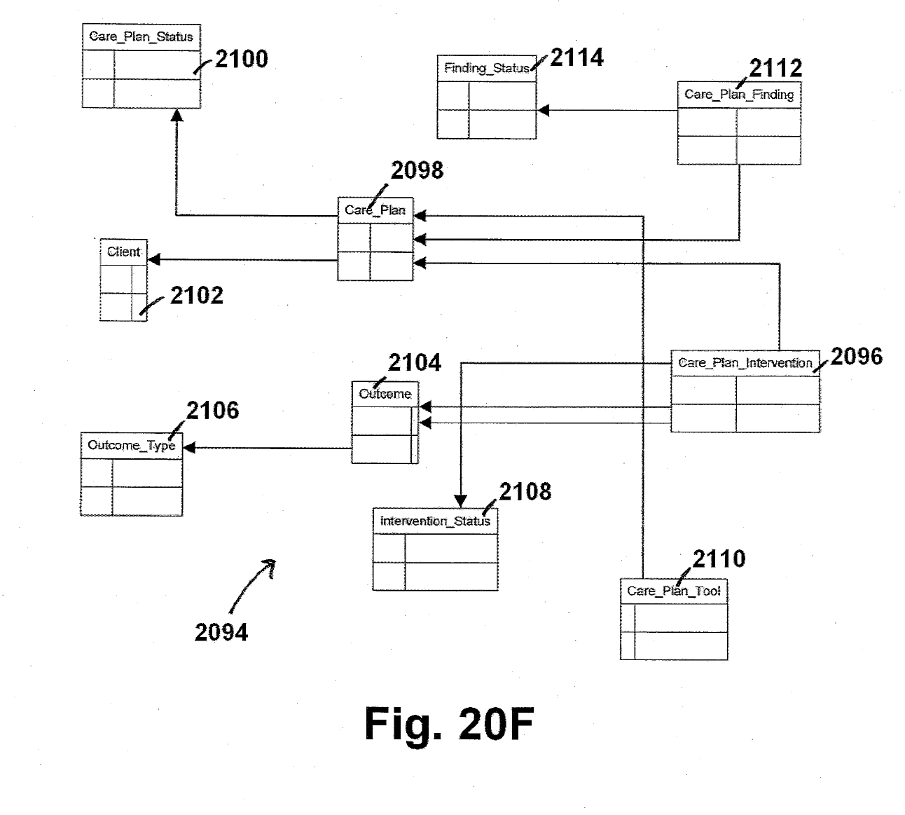

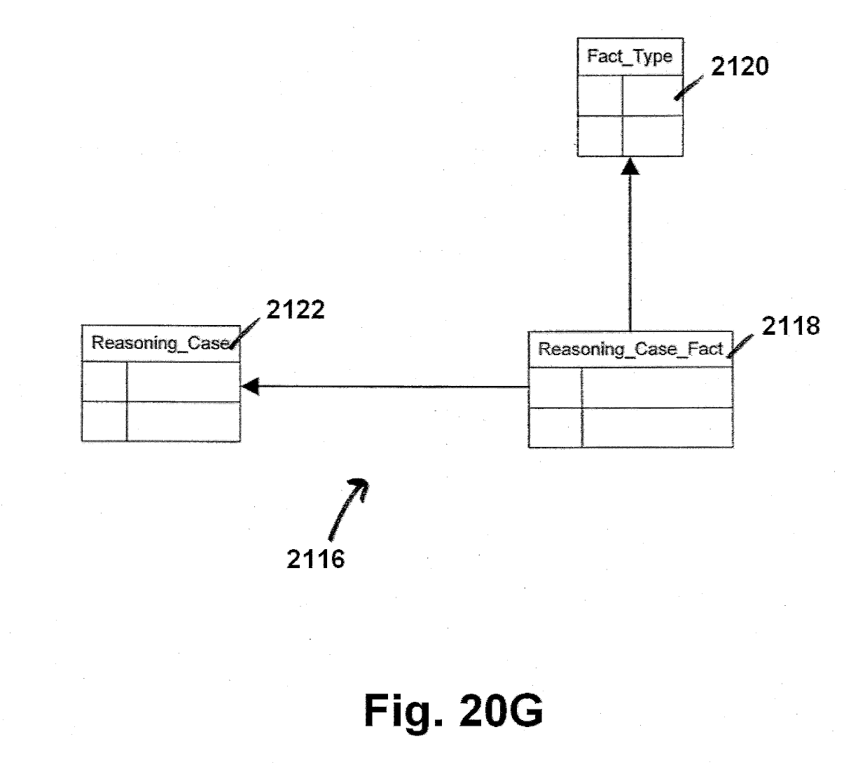

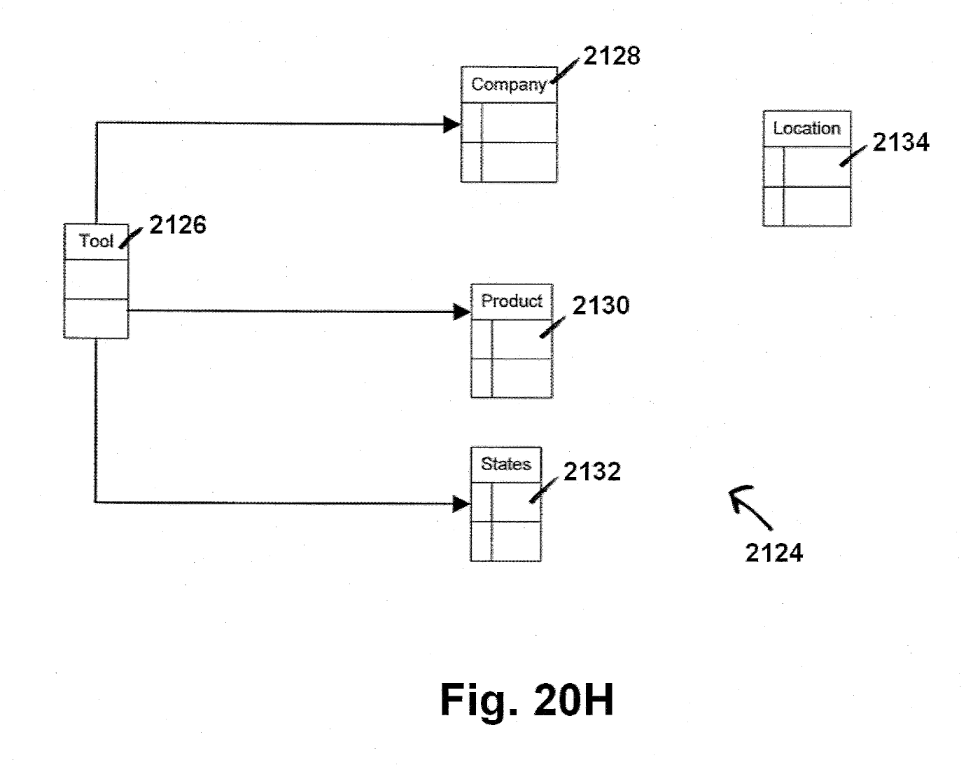

Exemplary entity relationship diagrams (ERDs) for several aspects of SCANS 104 are shown in FIGS. 20A-20H. FIG. 20A shows an exemplary client assessment ERD 2000 of the present disclosure, showing various tables and their corresponding exemplary relationships, including Actor of Care table 2002, Actor Of Care Type table 2004, Client table 2006, Question table 2008, Assessment Type table 2010, Evaluation Method table 2012, Decision Model table 2014, Decision Model Status table 2016, Answer Type table 2018, Answer Type Multiple Choice table 2020, and Qualifier table 2022. FIG. 20B shows an exemplary finding ERD 2024 of the present disclosure, showing the relationships between the following tables: Finding table 2026, Question table 2028, Question Status table 2030, Finding Type table 2032, Recommendation table 2034, and Association Role table 2036. An exemplary intervention tool ERD 2038 of the present disclosure is shown in FIG. 20C, including relationships between Intervention table 2040, Intervention Type table 2042, Priority table 2044, Intervention Tool table 2046, Tool table 2048, Finding Type table 2050, Finding Type table 2052, Recommendation table 2054, Association Role table 2056, Decision Model table 2058, and Finding table 2060.

FIG. 20D shows an exemplary source ERD 2062 of the disclosure of the present application. As shown in FIG. 20D, Source table 2064, Publication table 2066, Source Methodology table 2068, Source Finding table 2070 Finding table 2072, Source Keyword table 2074, Source Intervention table 2076, and Intervention table 2078 are provided along with their various relationships to one another. An exemplary decision model ERD 2080 is shown in FIG. 20E, along with the relationships between Decision Model Dependency table 2083, Decision Model table 2084, Decision Model status table 2086, Recommendation table 2088, Decision Model Message table 2090, and Message Type table 2092. FIG. 20F shows an exemplary client-care plan ERD 2094 of the present disclosure, including relationships between the following tables: Care Plan Intervention table 2096, Care Plan table 2098, Care Plan Status table 2100, Client table 2102, Outcome table 2104, Outcome Type table 2106, Intervention status table 2108, Care Plan Tool table 2110, Care Plan Finding table 2112, and Finding Status table 2114. An exemplary Reasoning-Case table 2116 of the present disclosure is shown in FIG. 20G, showing Reasoning Case Fact table 2118, Fact Type table 2120, and Reasoning Case table 2122, as well as their relationships to one another. FIG. 20H shows an exemplary private label brands ERD of the present disclosure, showing relationships between Tool table 2126, Company table 2128, Product table 2130, States table 2132, and Location table 2134. The various ERDs shown in FIGS. 20A through 20H are exemplary in nature, and the disclosure of the present application is not intended to be limited to any specific ERD or ERDs as referenced herein.

SCANS 104, as referenced herein, may transform the future of geriatric care providers by dramatically increasing care management skills and making practical tools readily available. Such a system 104 can provide HCMs with knowledge, experience, and tools otherwise unattainable by a single individual or small team. This expertise will be made directly available to clients and their families through their HCM. The benefit of better care management to clients is foremost, but exemplary systems of the present disclosure can also create a significant competitive differentiation and positive impact on productivity losses.

The various systems, methods, schema, ontologies, and architectures of the present disclosure may be used for purposes outside of the geriatric care field as referenced in the various examples cited herein. For example, summary architecture 800 may comprise various components and relationships suitable for use in any number of areas where various experiences are utilized and processed, with feedback being fed back into system componentry to improve overall system outcomes. In addition, various components described herein may share a name (or a portion thereof) but have duplicative reference numbers, and therefore the descriptions for the various components should read in view of one another.

In addition, and regarding the various systems of the present disclosure, such systems may be operable, as desired by a user of such systems, to generate visual, electronic (video, audio, database, transcript, etc.), and/or printed reports, outputs, outcomes, and the like. Such exemplary outputs may be used for any number of purposes, and may be useful generally to “report” results, data, and/or knowledge contained within and generated from such systems. Furthermore, the disclosure of the present application further encompasses uses of the various methods, systems, architectures, etc., to perform various tasks in connection therewith.

While various embodiments of senior care navigation systems and methods for using the same have been described in considerable detail herein, the embodiments are merely offered by way of non-limiting examples of the disclosure described herein. It will therefore be understood that various changes and modifications may be made, and equivalents may be substituted for elements thereof, without departing from the scope of the disclosure. Indeed, this disclosure is not intended to be exhaustive or to limit the scope of the disclosure.

Further, in describing representative embodiments, the disclosure may have presented a method and/or process as a particular sequence of steps. However, to the extent that the method or process does not rely on the particular order of steps set forth herein, the method or process should not be limited to the particular sequence of steps described. Other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. A system for utilizing and analyzing information to provide a desired outcome, the system comprising:
an evidence repository comprising at least one item of evidence from each of at least two evidentiary sources; and
a knowledge management and decision support system in communication with the evidence repository, the knowledge management and decision support system operable to retrieve the at least one item of evidence from the evidence repository and process the at least one item of evidence according to at least one reasoning approach, the knowledge management and decision support system further operable to generate at least one outcome.

2. The system of claim 1, wherein the at least two evidentiary sources are selected from the group consisting of standards of care, clinical expertise, and member records.

3. The system of claim 1, wherein at least one of the at least two evidentiary sources comprises standards of care, and wherein the standards of care comprise the at least one item of evidence selected from the group consisting of research reports, care guidelines, and practice standards.

4. The system of claim 1, wherein at least one of the at least two evidentiary sources comprises clinical expertise, and wherein the clinical expertise comprises field evidence.

5. The system of claim 1, wherein at least one of the at least two evidentiary sources comprises member records, and wherein the member records comprise internal research evidence from at least one member record source.

6. The system of claim 1, wherein the at least one item of evidence within the evidence repository was extracted and provided to the evidence repository by establishing patterns for translation from text from at least one of the at least two evidentiary sources to at least one medical ontology by observing regularities in the text and mapping the irregularities to control structures in the at least one medical ontology.

7. The system of claim 1, wherein the at least one reasoning approach is selected from the group consisting of rule-based reasoning, a Semantic Web inference engine, a Bayesian network model, a neural network, and case-based reasoning.

8. The system of claim 1, wherein the at least one reasoning approach comprises two reasoning approaches comprising rule-based reasoning and a Bayesain network model.

9. The system of claim 1, wherein the at least one outcome is selected from the group consisting of a member outcome, a case manager outcome, a cost/utility return-on-investment data, and a documented report.

10. The system of claim 1, wherein the at least one item of evidence within the evidence repository was extracted and provided to the evidence repository by abstracting the at least one item of evidence into one or more evidence tables, linking the one or more evidence tables in a knowledge base using an algorithm, and utilizing an ontology-driven extraction of linguistic patterns to reconstruct knowledge from at least one of the at least two evidentiary sources.

11. The system of claim 10, wherein the algorithm is selected from the group consisting of a concatenation algorithm and an unsupervised decision list algorithm, the unsupervised decision list algorithm operable to learn extraction patterns and based upon Population, Intervention or interest, Comparison intervention or group, and Outcome (PICO) search settings.

12. A method for utilizing and analyzing information to provide a desired outcome, the method comprising the steps of:
operating a system for utilizing and analyzing information to generate at least one outcome, the system comprising:
an evidence repository comprising at least one item of evidence from each of at least two evidentiary sources, and
a knowledge management and decision support system in communication with the evidence repository, the knowledge management and decision support system operable to retrieve evidence from the evidence repository and process the at least one item of evidence according to at least one reasoning approach, the knowledge management and decision support system further operable to generate at least one outcome; and
utilizing the at least one outcome to provide at least one service to a client.

13. A system for preparing a care plan, the system comprising:
a database capable of receiving client data; and
a processor operably connected to the database, the processor having and executing a program and operational to:
access one or more primary categories, one or more secondary categories within the one or more primary categories, and one or more tertiary categories within the one or more secondary categories;
access one or more findings, each of the one or more findings relating to one or more recommendations;
access one or more tools, the one or more tools capable of addressing one or more of the one or more recommendations;
display the one or more findings, the one or more recommendations, and the one or more tools in a desired order; and
create a care plan containing the one or more findings, the one or more recommendations, and the one or more tools, the care plan comprising data fields pertaining to the status of the one or more recommendations, the responsibility for addressing the one or more recommendations, and the completion of the one or more recommendations.

14. The system of claim 13, wherein the created care plan is stored within a storage medium operably connected to the processor, the storage medium capable of storing multiple care plans.

15. The system of claim 13, wherein the processor is further operational to execute the program to display multiple care plans.

16. A method for preparing a care plan, the method comprising the steps of:
entering assessment data into a case management system;
obtaining an assessment summary based upon the assessment date from the case management system;
creating a new care plan in a knowledge management and decision support system;
transferring the new care plan to the case management system; and
finalizing the new care plan in the case management system.

17. A system for managing the health care of a client, the system comprising:
a case management system operable to receive at least one of assessment data, case notes, and/or outcomes; and
a knowledge management and decision support system operable to receive case data from the case management system, the case data relating to the at least one of assessment data, case notes, and/or outcomes, the knowledge management and decision support system further operable to generate one or more care plans and to provide the one or more care plans to the ease management system.

18. The system of claim 17, wherein the generated one or more care plans facilitate client health care management.

19. The system of claim 17, wherein the knowledge management and decision support system is further operable to generate one or more tools and to provide the one or more tools to the case management system.

20. A method for managing health care of a client, the method comprising the steps of:
providing assessment data from at least one of a client, a client's family, and/or a client's spouse to a health care manager;
providing at least one of the assessment data, case notes, and/or outcomes from the health care manager to a case management system;
operating the case management system to compile case data and to provide the case data to a knowledge management and decision support system;
operating the knowledge management and decision support system to generate one or more care plans and to provide the one or more care plans to the case management system; and
providing at least one of the one or more care plans from the knowledge management and decision support system and additional client tools to at least one of the client, the client's family, and/or the client's spouse to manage the client's health care.

21. A system for mining information from various knowledge sources, the system comprising:
one or more knowledge sources;
a text mining mechanism operable to mine text from the one or more knowledge sources; and
a knowledge management and decision support system operable to:
obtain mined text from the text mining mechanism,
obtain information from the one or more knowledge sources either directly or by way of an intermediate expert, and
generate one or more plans comprising data based upon the information.

22. The system of claim 21, whereby the case data within the generated one or more plans becomes at least one of the one or more knowledge sources.

23. The system of claim 22, wherein the one or more plans comprises one or more care plans, and wherein the data comprises case data.

24. An architecture for mining literature, the architecture comprising:
one or more literature databases accessible by an object tagging mechanism;
one or more medical dictionaries in communication with an object identification mechanism, wherein the object identification mechanism utilizes one or more learning algorithms useful for at least one of concept tagging, identification, and/or association discovery;
one or more healthcare-specific knowledge bases in communication with the object tagging mechanism and the object identification mechanism;
a system interface;
a relationship identification; and
a user interface in communication with various dynamic user specific knowledge networks to allow a user to access said networks and portions of said architecture.

25. A method for generating terms using a term extraction algorithm, the method comprising the steps of:
identifying unique tokens appearing in each document of a training corpus;
calculating a frequency of each unique token in each document, the total number of documents in which each unique token appears, and a total number of documents in a training set;
converting the frequency of each unique token to a weight; and
ranking a list of each unique tokens by its weight.
